(19) United States
(12) Patent Application Publication
(10) Pub. No.: US 2026/0177198 A1
(43) Pub. Date: Jun. 25, 2026

(54) VARIABLE LEVEL GATE ASSEMBLY WITH PLATFORM

(71) Applicant: Diverse Holdings, LLC, Delaware, OH (US)

(72) Inventors: Carl L. Stover, Ostrander, OH (US); Craig T. Jones, Johnstown, OH (US)

(21) Appl. No.: 19/542,344

(22) Filed: Feb. 17, 2026

Related U.S. Application Data
(60) Provisional application No. 63/735,009, filed on Dec. 17, 2024.

(51) Int. Cl. F16M 11/24; F16M 11/08; F16M 11/20

(52) U.S. Cl. CPC F16M 11/24; F16M 11/08; F16M 11/2092

(57) ABSTRACT

A gate assembly comprising a first side support assembly including a first fixed frame assembly and a first movable vertical frame configured to move vertically with respect to the first fixed frame assembly, a second side support assembly including a second fixed frame assembly and a second movable vertical frame configured to move vertically with respect to the second fixed frame assembly, a central platform assembly extending between and operably connected to the first movable vertical frame and the second movable vertical frame, the central platform assembly configured to move vertically between an elevated position and a lowered position, and a gate arm assembly mounted to at least one of the first side support assembly and the second side support assembly, the gate arm assembly providing a barrier forward of the central platform assembly.

### CROSS-REFERENCE TO RELATED APPLICATIONS

This application claims priority to U.S. Provisional Application No. 63/735,009, titled VARIABLE LEVEL GATE ASSEMBLY, filed Dec. 17, 2024, which is hereby incorporated by reference in its entirety.

### FIELD OF INVENTION

The present disclosure relates to safety gates for elevated platforms, and more particularly to a mezzanine gate assembly featuring a vertically adjustable, self-leveling central platform.

### BACKGROUND

Mezzanines and mezzanine floor systems are semi-permanent floor systems frequently utilized in industrial operations with high ceilings, such as warehousing, distribution centers, and manufacturing facilities. These elevated platforms are typically constructed between two permanent original stories, allowing otherwise unused vertical space to be utilized for storage, operations, or other purposes. Railings, chains, and other barrier systems typically provide safety protection around the periphery of these elevated areas.

Industrial mezzanines often include delivery openings where goods are transferred between the elevated platform and ground-level operations using forklifts and other material handling equipment. These openings create discontinuities in the perimeter railing systems, presenting fall hazards for workers positioned on or near the mezzanine structure. Workers accessing, delivering, and receiving goods at these elevated platforms may be exposed to fall risks during loading and unloading operations.

Various approaches have been developed to address fall protection at mezzanine delivery openings. Some systems require workers to connect themselves to the mezzanine structure using cables or other tethering means, which can be time-consuming and may not be consistently followed. Other systems employ gate assemblies that provide barriers at the delivery opening, though these may present challenges in accommodating the vertical and horizontal movements associated with forklift operations and load handling.

The handling of loads at elevated platforms presents additional considerations beyond fall protection. Loads delivered by forklift may vary in weight, requiring platforms or receiving surfaces that can accommodate different load conditions. Additionally, workers may benefit from the ability to reposition loads for more convenient access during unloading operations. The integration of load handling features with fall protection systems presents design considerations for mezzanine gate assemblies.

### SUMMARY

The presently disclosed subject matter is directed to a gate assembly. The gate assembly comprises a first side support assembly including a first fixed frame assembly and a first movable vertical frame configured to move vertically with respect to the first fixed frame assembly. The gate assembly comprises a second side support assembly including a second fixed frame assembly and a second movable vertical frame configured to move vertically with respect to the second fixed frame assembly. The gate assembly comprises a central platform assembly extending between and operably connected to the first movable vertical frame and the second movable vertical frame. The central platform assembly is configured to move vertically between an elevated position and a lowered position. The gate assembly comprises a gate arm assembly mounted to at least one of the first side support assembly and the second side support assembly. The gate arm assembly provides a barrier forward of the central platform assembly.

In some embodiments, the central platform assembly comprises a slidable platform and a rotatable upper platform positioned above the slidable platform. The rotatable upper platform is configured to rotate relative to the slidable platform.

In some embodiments, the gate assembly further comprises a rotational rolling-element bearing operably positioned between the slidable platform and the rotatable upper platform.

In some embodiments, the rotational rolling-element bearing comprises a slewing ring bearing.

In some embodiments, the first side support assembly further comprises a first plurality of springs creating elastic tension between the first fixed frame assembly and the first movable vertical frame. The second side support assembly further comprises a second plurality of springs creating elastic tension between the second fixed frame assembly and the second movable vertical frame.

In some embodiments, the central platform assembly is configured to self-level by moving vertically upward as a load is removed from the central platform assembly through tension of the first plurality of springs and the second plurality of springs.

In some embodiments, the gate arm assembly comprises an exterior gate assembly including a first exterior gate side arm and a second exterior gate side arm. The gate arm assembly comprises an interior gate assembly including a first interior gate side arm and a second interior gate side arm.

In some embodiments, each of the first exterior gate side arm, the second exterior gate side arm, the first interior gate side arm, and the second interior gate side arm is connected via a dual axis hinge configured to enable movement about a first directional axis and a second directional axis.

In some embodiments, each dual axis hinge comprises a self-closing hinge configured to bias a respective gate side arm to a default closed position.

The presently disclosed subject matter is directed to a gate assembly. The gate assembly comprises a first side support assembly. The first side support assembly includes a first fixed frame assembly having at least one vertical guide rod and a first spring connection member. The first side support assembly includes a first movable vertical frame having one or more deck guides configured to couple with the at least one vertical guide rod, thereby allowing the first movable vertical frame to move vertically with respect to the first fixed frame assembly, and a second spring connection member. The first side support assembly includes a first plurality of springs connecting the first spring connection member to the second spring connection member, thereby creating elastic tension between the first fixed frame assembly and the first movable vertical frame. The gate assembly comprises a second side support assembly. The second side support assembly includes a second fixed frame assembly having at least one vertical guide rod and a third spring connection member. The second side support assembly includes a second movable vertical frame having one or more deck guides configured to couple with the at least one vertical guide rod of the second fixed frame assembly, thereby allowing the second movable vertical frame to move vertically with respect to the second fixed frame assembly, and a fourth spring connection member. The second side support assembly includes a second plurality of springs connecting the third spring connection member to the fourth spring connection member, thereby creating elastic tension between the second fixed frame assembly and the second movable vertical frame. The gate assembly comprises a central platform assembly extending between and operably connected to the first movable vertical frame and the second movable vertical frame. The central platform assembly is configured to move vertically between an elevated position and a lowered position responsive to a load placed thereon. The gate assembly comprises a gate arm assembly mounted to at least one of the first side support assembly and the second side support assembly.

In some embodiments, the central platform assembly comprises a slidable platform and a rotatable upper platform positioned above the slidable platform. The rotatable upper platform is configured to rotate relative to the slidable platform.

In some embodiments, the gate assembly further comprises a rotational rolling-element bearing operably positioned between the slidable platform and the rotatable upper platform. The rotational rolling-element bearing comprises a slewing ring bearing.

In some embodiments, each of the first fixed frame assembly and the second fixed frame assembly further comprises a top support member, a base support member, a forward member extending vertically between the top support member and the base support member, and a rear member extending vertically between the top support member and the base support member.

In some embodiments, each of the first fixed frame assembly and the second fixed frame assembly further comprises first side parallel vertical cam guides positioned along the forward member and second side parallel vertical cam guides positioned along the rear member.

In some embodiments, each of the first movable vertical frame and the second movable vertical frame further comprises cam followers configured to translate along the first side parallel vertical cam guides and the second side parallel vertical cam guides.

In some embodiments, the gate arm assembly comprises an exterior gate assembly and an interior gate assembly. The exterior gate assembly includes opposing exterior gate side arms and the interior gate assembly includes opposing interior gate side arms. Each of the exterior gate side arms and the interior gate side arms is connected via a dual axis hinge configured to enable movement about a first directional axis and a second directional axis.

The presently disclosed subject matter is directed to a gate assembly. The gate assembly comprises a first side support assembly. The first side support assembly includes a first fixed frame assembly having a first guide rod and a second guide rod extending vertically between a top support member and a base support member, a first spring connection member positioned near the top support member, and first side parallel vertical cam guides and second side parallel vertical cam guides. The first side support assembly includes a first movable vertical frame having a first deck guide and a second deck guide configured to couple with the first guide rod and the second guide rod respectively, first side cam followers configured to translate along the first side parallel vertical cam guides, second side cam followers configured to translate along the second side parallel vertical cam guides, and a second spring connection member. The first side support assembly includes a first plurality of springs connecting the first spring connection member to the second spring connection member. The gate assembly comprises a second side support assembly. The second side support assembly includes a second fixed frame assembly having at least one vertical guide rod and a second spring connection member. The second side support assembly includes a second movable vertical frame configured to move vertically with respect to the second fixed frame assembly. The second side support assembly includes a second plurality of springs creating elastic tension between the second fixed frame assembly and the second movable vertical frame. The gate assembly comprises a central platform assembly extending between and operably connected to the first movable vertical frame and the second movable vertical frame. The central platform assembly includes a slidable platform and a rotatable upper platform positioned above the slidable platform. The rotatable upper platform is configured to rotate relative to the slidable platform via a rotational rolling-element bearing. The gate assembly comprises a gate arm assembly including an exterior gate assembly and an interior gate assembly. Each of the exterior gate assembly and the interior gate assembly includes gate side arms connected via dual axis hinges enabling movement about a first directional axis and a second directional axis.

In some embodiments, the first movable vertical frame further comprises a first side guide block and a second side guide block configured to provide additional guidance during vertical translation of the first movable vertical frame.

In some embodiments, the first side cam followers and the first side guide blocks are positioned at upper and lower locations on the first movable vertical frame. The second side cam followers and the second side guide blocks are positioned at upper and lower locations on the first movable vertical frame.

In some embodiments, the central platform assembly further comprises a platform support assembly including guide rails extending along each side of the central platform assembly, upper rollers, and lower rollers engaging with the guide rails to enable horizontal sliding movement of the slidable platform relative to the first side support assembly and the second side support assembly.

### BRIEF DESCRIPTION OF FIGURES

Non-limiting and non-exhaustive examples are described with reference to the following figures.

FIG. 1 illustrates a front perspective view of a gate assembly in a gate-closed, platform-elevated default position, according to aspects of the present disclosure.

FIG. 2 illustrates a front perspective view of the gate assembly of FIG. 1 in a gate-closed, platform-elevated default position, according to an embodiment.

FIG. 3 illustrates a front perspective view of the gate assembly of FIG. 1 in a gate-closed, platform-lowered position, according to aspects of the present disclosure.

FIG. 4 illustrates a front perspective view of the gate assembly of FIG. 1 in a gate-closed, platform-lowered position, according to an embodiment.

FIG. 5 illustrates a rear perspective view of the gate assembly of FIG. 1 in a gate-closed, platform-elevated default position, according to aspects of the present disclosure.

FIG. 6 illustrates a rear perspective view of the gate assembly of FIG. 1 in a gate-closed, platform-elevated default position, according to an embodiment.

FIG. 7 illustrates a rear perspective view of the gate assembly of FIG. 1 in a gate-closed, platform-lowered position, according to aspects of the present disclosure.

FIG. 8 illustrates a rear perspective view of the gate assembly of FIG. 1 in a gate-closed, platform-lowered position, according to an embodiment.

FIG. 9 illustrates a front perspective view of the gate assembly of FIG. 1 in a gate-open, arms-rearward, platform-elevated position, according to aspects of the present disclosure.

FIG. 10 illustrates a front perspective view of the gate assembly of FIG. 1 in a gate-open, arms-upward, platform-elevated position, according to an embodiment.

FIG. 11 illustrates a front perspective view of the gate assembly of FIG. 1 in a gate-closed, platform-lowered position showing rotation of the rotatable upper platform, according to aspects of the present disclosure.

FIG. 12 illustrates a front perspective view of the gate assembly of FIG. 1, showing the slidable platform in a rearward position, according to an embodiment.

FIG. 13 illustrates a top plan view of the gate assembly of FIG. 1 in a gate-closed position, according to aspects of the present disclosure.

FIG. 14 illustrates a front elevation view of the gate assembly of FIG. 1 in a gate-closed, platform-elevated default position, according to an embodiment.

FIG. 15 illustrates a rear elevation view of the gate assembly of FIG. 1 in a gate-closed, platform-elevated default position, according to aspects of the present disclosure.

FIG. 16 illustrates an elevation view of a platform support assembly attached to movable vertical frames, according to an embodiment.

FIG. 17 illustrates an elevation view of a central platform assembly, including the slidable platform 108 and rotatable upper platform 110 attached to the movable vertical frames of FIG. 16, according to aspects of the present disclosure.

FIG. 18 illustrates a bottom plan view of the rotatable upper platform with a rotational rolling-element bearing or means for rotating, according to an embodiment.

FIG. 19 illustrates a first side elevation view of the gate assembly of FIG. 1 in the platform-elevated default position, according to aspects of the present disclosure.

FIG. 20 illustrates a second side elevation view of the gate assembly of FIG. 1 in the platform-elevated default position, according to an embodiment.

FIG. 21 illustrates a first side elevation view of a side support assembly with a movable vertical frame in an elevated position, according to aspects of the present disclosure.

FIG. 22 illustrates a first side elevation view of the side support assembly of FIG. 21 with the movable vertical frame in a lowered position, according to an embodiment.

FIG. 23 illustrates a front elevation view of the movable vertical frame of FIG. 21, according to aspects of the present disclosure.

FIG. 24 illustrates a first perspective view of a fixed frame assembly, according to an embodiment.

FIG. 25 illustrates a second perspective view of the fixed frame assembly of FIG. 24, according to aspects of the present disclosure.

FIG. 26 illustrates an exploded view of the gate assembly of FIG. 1, according to an embodiment.

FIG. 27 illustrates an exploded view of the gate assembly of FIG. 1, according to aspects of the present disclosure.

FIG. 28 illustrates a perspective operational view of a gate assembly installed on a mezzanine, shown when in a gate-closed, platform-elevated default position, according to an embodiment.

FIG. 29 illustrates a perspective operational view of the gate assembly of FIG. 28 in the gate-closed, platform-elevated default position, showing a load prior to delivery to the gate opening, according to aspects of the present disclosure.

FIG. 30 illustrates a perspective operational view of the gate assembly of FIG. 28 receiving a load onto the central platform assembly, according to an embodiment.

FIG. 31 illustrates a perspective operational view of the gate assembly of FIG. 28 receiving a load, the platform lowered, and the gate arms moved rearward, according to aspects of the present disclosure.

FIG. 32 illustrates a perspective operational view of the gate assembly of FIG. 28 with a load delivered to the central platform assembly, according to an embodiment.

FIG. 33 illustrates a perspective operational view of the gate assembly of FIG. 28, with the rotatable upper platform rotated and a load thereon, according to aspects of the present disclosure.

FIG. 34 illustrates a perspective operational view of the gate assembly of FIG. 28 in a gate-closed, platform-lowered loaded position, and the central platform assembly moved rearward, according to an embodiment.

FIG. 35 illustrates a perspective operational view of the gate assembly of FIG. 28 in a gate-closed, platform-lowered loaded position, and the central platform assembly moved rearward, according to an embodiment.

FIG. 36 illustrates a front perspective view of the gate assembly of FIG. 28 in a gate-closed, platform-elevated, unloaded default position, according to an embodiment.

FIG. 37 illustrates a perspective view of a side support assembly showing internal components, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

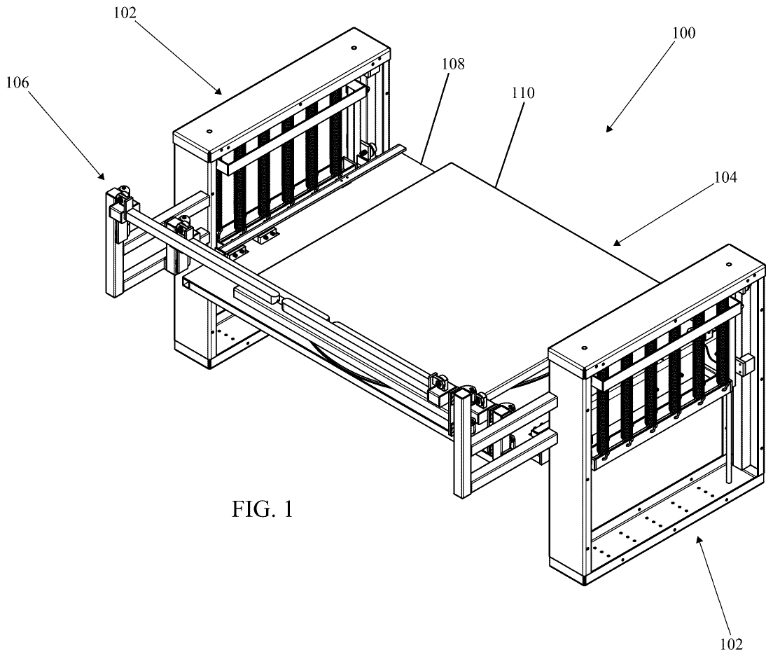

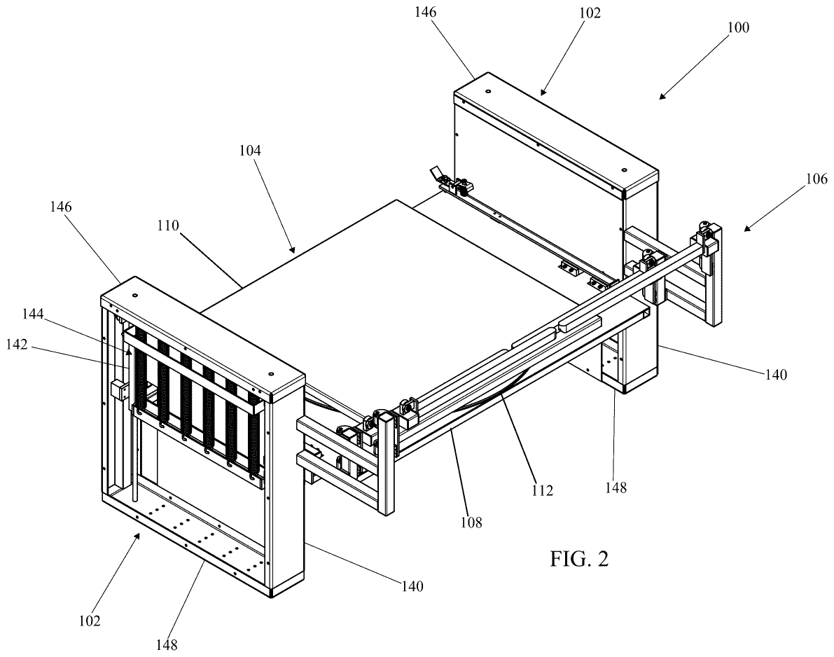

Referring to FIG. 1 and FIG. 2, a gate assembly 100 is shown in a gate-closed, platform-elevated default position. The gate assembly 100 may be adapted to provide ingress and egress to an elevated platform while safely preventing falls and injury to workers positioned thereon or below the elevated platform. The gate assembly 100 may be operably positioned along the edge of an elevated platform at a delivery opening to provide continuity with a perimeter railing. In some cases, the gate assembly 100 is designed to meet or exceed industry standards.

The gate assembly 100 may generally comprise a side support assembly 102 positioned on each lateral side of the structure, a central platform assembly 104 extending between the side support assemblies 102, and a gate arm assembly 106 mounted to at least one of the side support assemblies 102. The side support assemblies 102 may provide structural support and house internal components that enable vertical movement of the central platform assembly 104. The central platform assembly 104 may be configured to move vertically between an unloaded elevated position and a lowered loaded position. The gate arm assembly 106 may provide a barrier forward of the central platform assembly 104.

With continued reference to FIG. 1 and FIG. 2, the central platform assembly 104 may include a slidable platform 108 and a rotatable upper platform 110 positioned above the slidable platform 108. The rotatable upper platform 110 may be configured to rotate relative to the slidable platform 108. The slidable platform 108 may extend horizontally rearward between the two side support assemblies 102.

The gate assembly 100 may function to provide a continuous barrier at a delivery opening and between existing railings throughout the delivery of goods to an elevated platform by way of a forklift. When a load is delivered to the central platform assembly 104, the central platform assembly 104 may be caused to move from the elevated position to the lowered position by way of gravity applying a downward force to the load. Conversely, the central platform assembly 104 may be self-leveling in that as the load is removed from the central platform assembly 104, the central platform assembly 104 incrementally moves vertically upward until the load is completely removed, returning to the elevated position. The gate arm assembly 106 may be mounted near the top of each side support assembly 102 and may provide a horizontal barrier forward of the central platform assembly 104 to maintain fall protection at the delivery opening.

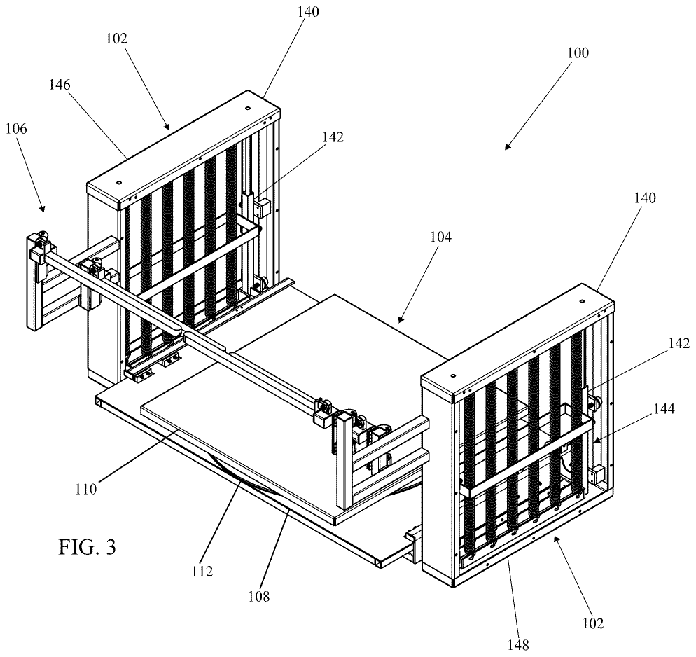

Referring to FIG. 2 and FIG. 3, the gate assembly 100 is shown in a gate-closed, platform-elevated default position and a gate-closed, platform-lowered position, respectively. Each side support assembly 102 may comprise a fixed frame assembly 140 and a movable vertical frame 142. The fixed frame assembly 140 may provide structural support for the gate assembly 100, while the movable vertical frame 142 may be configured to move vertically with respect to the fixed frame assembly 140. The central platform assembly 104 extends between and is operably connected to the movable vertical frame 142 on each side, allowing the central platform assembly 104 to move vertically between an elevated position and a lowered position.

With continued reference to FIG. 2 and FIG. 3, each side support assembly 102 may further comprise a plurality of springs 144 creating elastic tension between the fixed frame assembly 140 and the movable vertical frame 142. The plurality of springs 144 may extend vertically within each side support assembly 102, connecting between the fixed frame assembly 140 and the movable vertical frame 142. When a load is delivered to the central platform assembly 104, the central platform assembly 104 may be caused to move from the elevated position to the lowered position by way of gravity applying a downward force to the load. The downward force produced by the weight of the load may be countered by an upward force created by the plurality of springs 144.

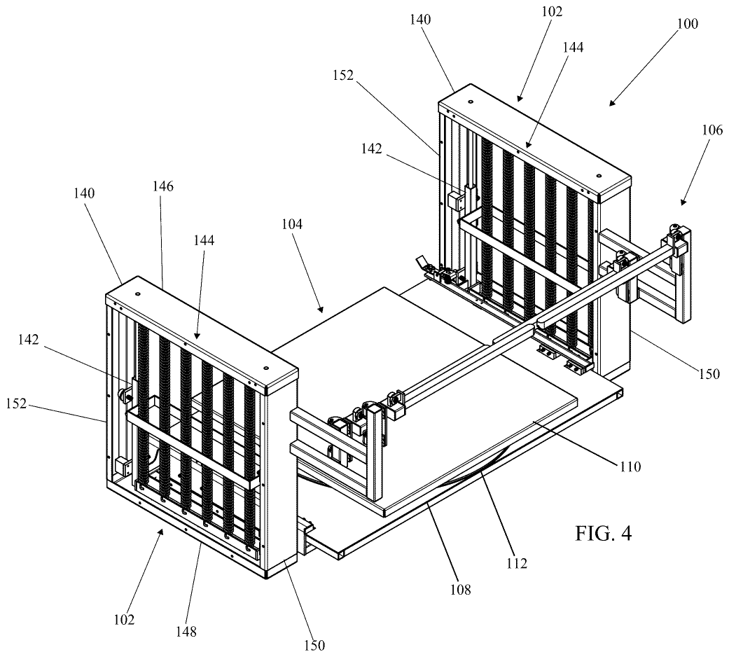

Referring to FIG. 3 and FIG. 4, the gate assembly 100 is shown in a gate-closed, platform-lowered position. The central platform assembly 104 may be configured to self-level by moving vertically upward as a load is removed from the central platform assembly 104 through tension of the plurality of springs 144 on each side. As the load is incrementally removed from the central platform assembly 104, the central platform assembly 104 incrementally moves vertically upward until the load is completely removed, returning to the elevated, default position. The fixed frame assembly 140 on each side may include a top support member 146 at an upper portion and a base support member 148 at a lower portion. A forward member 150 and a rear member 152 may extend vertically between the top support member 146 and the base support member 148, forming a structural framework for each side support assembly 102.

With continued reference to FIG. 2 and FIG. 4, the central platform assembly 104 includes the slidable platform 108 and the rotatable upper platform 110 positioned above the slidable platform 108. A rotational rolling-element bearing 112 may be operably positioned between the slidable platform 108 and the rotatable upper platform 110. The rotational rolling-element bearing 112 may enable the rotatable upper platform 110 to rotate relative to the slidable platform 108. In some cases, the rotational rolling-element bearing 112 comprises a slewing ring bearing or turntable mechanism that supports rotational movement of loads placed on the rotatable upper platform 110.

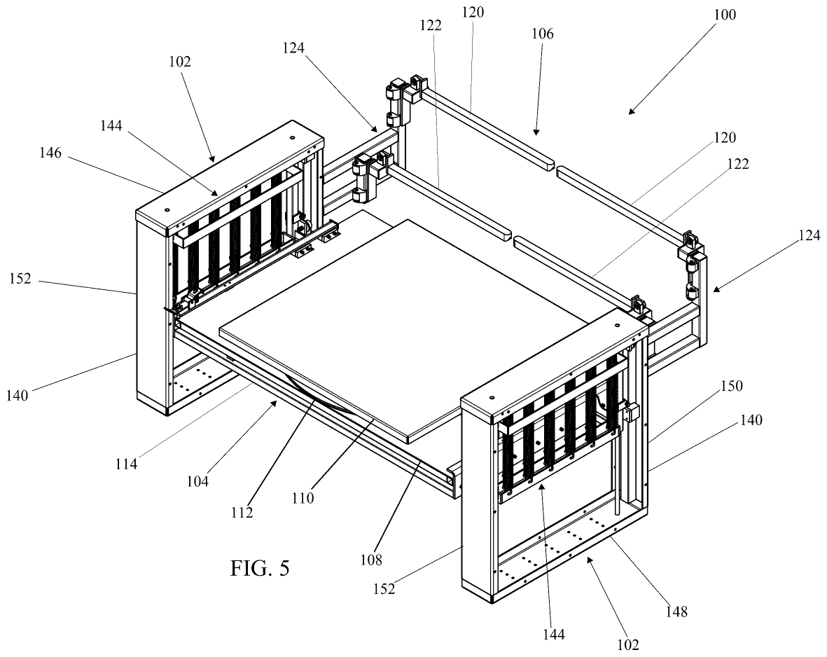

Referring to FIG. 5, a rear perspective view of the gate assembly 100 is shown when in the gate-closed, platform-elevated default position. The gate assembly 100 includes a first side support assembly 102, a second side support assembly 102, the central platform assembly 104, and the gate arm assembly 106. Each side support assembly 102 comprises the fixed frame assembly 140 having the top support member 146, the base support member 148, the forward member 150, and the rear member 152. The fixed frame assembly 140 provides structural support for the movable components of the gate assembly 100. The plurality of springs 144 is positioned within each side support assembly 102, extending vertically to provide elastic tension for the vertical movement of the central platform assembly 104.

With continued reference to FIG. 5, the central platform assembly 104 includes a platform support assembly 114, the slidable platform 108, and the rotatable upper platform 110 positioned above the slidable platform 108. The rotational rolling-element bearing 112 is operably connected to the rotatable upper platform 110, enabling the rotatable upper platform 110 to rotate relative to the slidable platform 108. The platform support assembly 114 is positioned beneath the slidable platform 108 to support and facilitate movement of the slidable platform 108.

The gate arm assembly 106 includes a first side support structure 124 and a second side support structure 124, each mounted to the forward member 150 of the respective fixed frame assembly 140 of each side support assembly 102. The gate arm assembly 106 is mounted to at least one of the first side support assembly 102 and the second side support assembly 102. Each of the side support structures 124 supports a first exterior gate side arm 120 and a first interior gate side arm 122, which extend horizontally to provide a barrier forward of the central platform assembly 104. The gate arm assembly 106 provides a barrier forward of the central platform assembly 104 when in a default closed position.

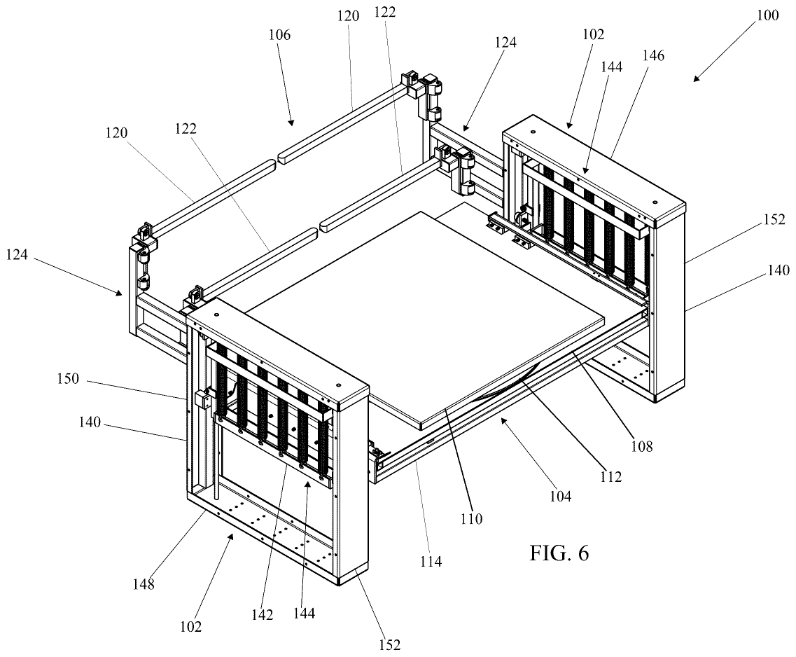

Referring to FIG. 6, a rear-side perspective view of the gate assembly 100 is shown in the gate-closed, platform-elevated default position. Each of the side support assemblies 102 comprises the fixed frame assembly 140 and the movable vertical frame 142. The fixed frame assembly 140 includes the top support member 146 at the upper portion, the base support member 148 at the lower portion, the forward member 150, and the rear member 152 extending vertically between the top support member 146 and the base support member 148. The plurality of springs 144 is visible within each side support assembly 102, extending vertically to provide elastic tension between the fixed frame assembly 140 and the movable vertical frame 142.

With continued reference to FIG. 6, the central platform assembly 104 includes the slidable platform 108 and the rotatable upper platform 110 positioned above the slidable platform 108. The rotational rolling-element bearing 112 is operably associated with the rotatable upper platform 110. The platform support assembly 114 is a part of the central platform assembly 104 and is positioned beneath the slidable platform 108 to provide structural support.

The gate arm assembly 106 includes opposing side support structures 124 that provide mounting support for the gate arms. The gate arm assembly 106 may comprise an exterior gate assembly 116 and an interior gate assembly 118. The exterior gate assembly 116 includes a first exterior gate side arm 120 and a second exterior gate side arm 120, which extend horizontally to form an exterior barrier forward of the central platform assembly 104. The interior gate assembly 118 includes a first interior gate side arm 122 and a second interior gate side arm 122, which extend horizontally to form an interior barrier forward of the central platform assembly 104. The first exterior gate side arm 120 and the second exterior gate side arm 120 may be longitudinally aligned to form the exterior barrier, and the first interior gate side arm 122 and the second interior gate side arm 122 may be longitudinally aligned to form the interior barrier.

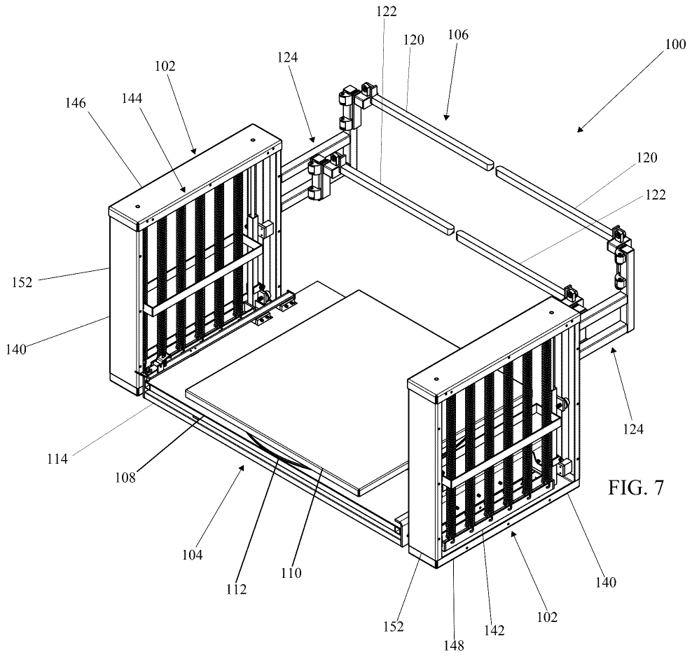

Referring to FIG. 7, a rear perspective view of the gate assembly 100 is shown when in the gate-closed, platform-lowered position with the plurality of springs 144 visible. Each side support assembly 102 comprises the fixed frame assembly 140 and the movable vertical frame 142. The fixed frame assembly 140 includes the top support member 146 at the upper portion, the base support member 148 at the lower portion, and the rear member 152 extending vertically between the top support member 146 and the base support member 148. The gate assembly 100 may provide a continuous barrier at a delivery opening and between existing railings throughout the delivery of goods to an elevated platform by way of a forklift.

With continued reference to FIG. 7, the central platform assembly 104 includes the slidable platform 108 and the rotatable upper platform 110 positioned above the slidable platform 108. The rotational rolling-element bearing 112 is operably associated with the rotatable upper platform 110. The platform support assembly 114 is positioned beneath the slidable platform 108 to provide structural support for the central platform assembly 104. The exterior gate side arm 120 and the interior gate side arm 122 extend horizontally to form an exterior barrier and an interior barrier forward of the central platform assembly 104.

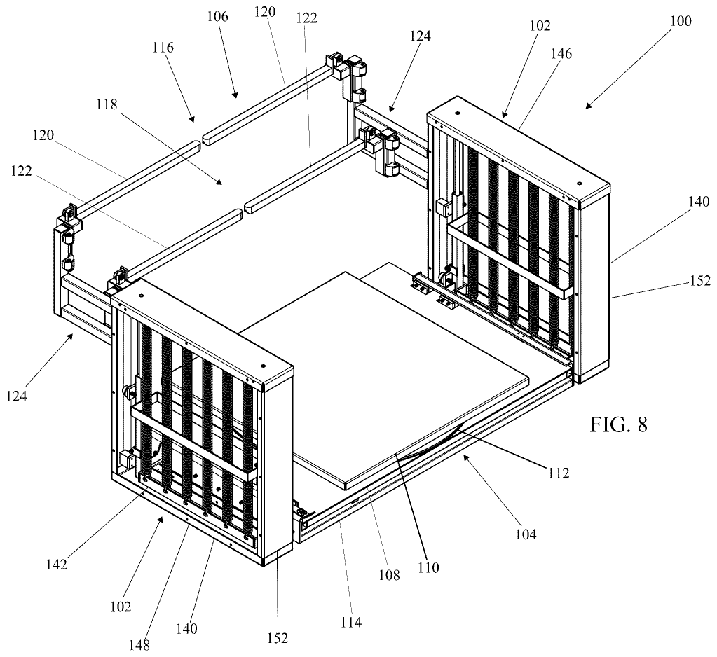

Referring to FIG. 8, a rear perspective view of the gate assembly 100 is shown when in the gate-closed, platform-lowered position. Each side support assembly 102 comprises the fixed frame assembly 140 and the movable vertical frame 142. The central platform assembly 104 is affixed at each side to a respective movable vertical frame 142 and includes the platform support assembly 114, the slidable platform 108 thereabove, and the rotatable upper platform 110 positioned above the slidable platform 108. The rotational rolling-element bearing 112 is operably associated with the rotatable upper platform 110, enabling the rotatable upper platform 110 to rotate relative to the slidable platform 108.

As further shown in FIG. 8, the gate arm assembly 106 includes the exterior gate assembly 116 and the interior gate assembly 118. The exterior gate assembly 116 includes the first exterior gate side arm 120 and the second exterior gate side arm 120, which, when aligned, form the exterior barrier. The interior gate assembly 118 includes the first interior gate side arm 122 and the second interior gate side arm 122, which, when aligned, form the interior barrier. Each gate arm assembly 106 is supported by the side support structure 124 that is affixed to the respective fixed frame assembly 140 of the side support assembly 102. The first exterior gate side arm 120, the second exterior gate side arm 120, the first interior gate side arm 122, and the second interior gate side arm 122 collectively form a horizontal barrier forward of the central platform assembly 104 when in a default closed position. The gate assembly 100 may define adjacent first and second side openings with the central platform assembly 104 centrally positioned therebetween.

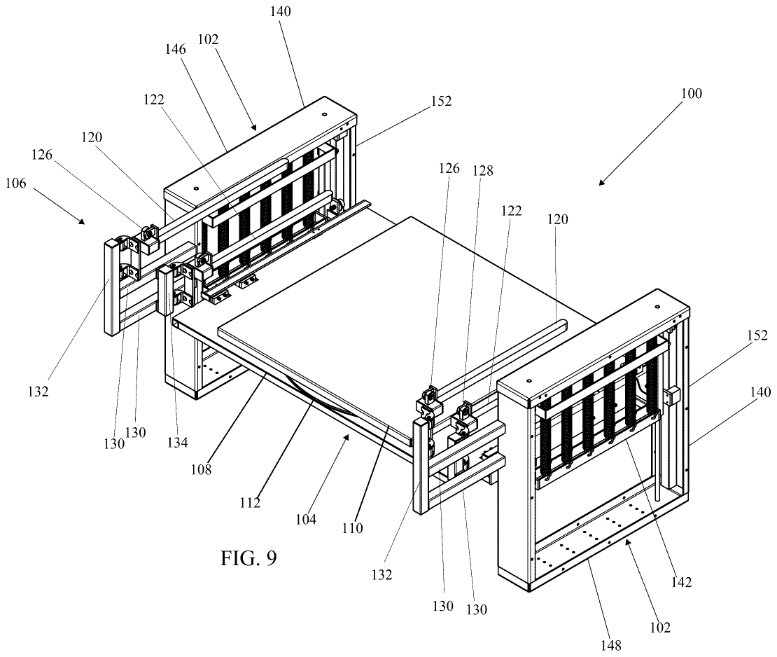

Referring to FIG. 9, a front perspective view of the gate assembly 100 is shown in a gate-open, arms-rearward, platform-elevated position. The gate assembly 100 includes the side support assembly 102 positioned on each side, with the central platform assembly 104 extending between the two side support assemblies 102. Each side support assembly 102 comprises the fixed frame assembly 140 that provides structural support for the gate assembly 100. The fixed frame assembly 140 includes the top support member 146 at the upper portion and the base support member 148 at the lower portion. The rear member 152 extends vertically between the top support member 146 and the base support member 148 on each side support assembly 102. The movable vertical frame 142 is shown positioned within the fixed frame assembly 140 on each side, configured to translate vertically along the fixed frame assembly 140.

With continued reference to FIG. 9, the central platform assembly 104 includes the slidable platform 108 and the rotatable upper platform 110 positioned above the slidable platform 108. The rotational rolling-element bearing 112 is operably associated with the rotatable upper platform 110, enabling the rotatable upper platform 110 to rotate relative to the slidable platform 108.

The gate arm assembly 106 on each side includes the side support structure 124. The side support structure 124 may comprise a pair of parallel horizontal members 130, an exterior vertical member 132 connecting the horizontal members 130, and an interior vertical member 134. The exterior vertical member 132 and the interior vertical member 134 extend vertically from the horizontal members 130 to support the gate arms.

The horizontal members 130 on each side project forward of and are affixed to the forward member 150 respectively.

As further shown in FIG. 9, the exterior gate side arms 120 and the interior gate side arms 122 extend horizontally from each side support structure 124, namely from the exterior vertical member 132 and the interior vertical member 134, respectively, to form the exterior barrier and the interior barrier forward of the central platform assembly 104. The exterior gate side arms 120 are connected via a dual axis hinge 126 at each side, and the interior gate side arms 122 are connected via a dual axis hinge 128 at each side. The dual axis hinge 126 and the dual axis hinge 128 may enable the respective exterior gate side arms 120 and interior gate side arms 122 to move about a first directional axis and a second directional axis, allowing the gate arms to articulate upward and rearward from a default closed position.

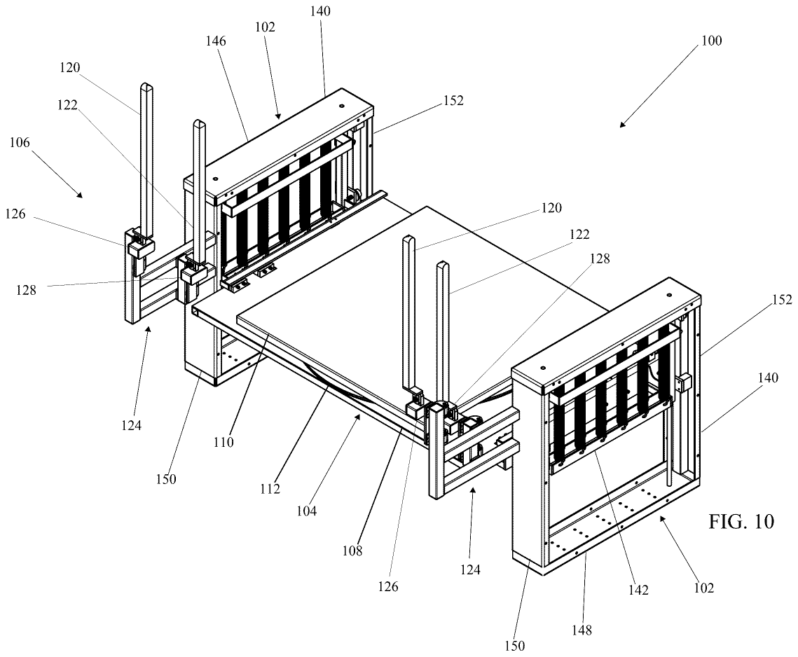

Referring to FIG. 10, a front perspective view of the gate assembly 100 is shown in a gate-open, arms-upward, platform-elevated position. The gate assembly 100 includes the side support assembly 102 positioned on each lateral side, with the central platform assembly 104 extending horizontally between the two side support assemblies 102. Each side support assembly 102 comprises the fixed frame assembly 140 and the movable vertical frame 142. The fixed frame assembly 140 includes the top support member 146 at the upper portion and the base support member 148 at the lower portion. The forward member 150 and the rear member 152 extend vertically between the top support member 146 and the base support member 148, forming the structural framework of each side support assembly 102.

With continued reference to FIG. 10, the central platform assembly 104 includes the slidable platform 108 and the rotatable upper platform 110 positioned above the slidable platform 108. The rotational rolling-element bearing 112 is operably positioned between the slidable platform 108 and the rotatable upper platform 110, enabling the rotatable upper platform 110 to rotate relative to the slidable platform 108.

The gate arm assembly 106 is mounted near the front, upper side of the side support assembly 102 and includes the side support structure 124 on each side. The gate arm assembly 106 comprises the exterior gate assembly 116 and the interior gate assembly 118. The exterior gate assembly 116 includes the first exterior gate side arm 120 and the second exterior gate side arm 120 extending horizontally to form the exterior barrier forward of the central platform assembly 104. The interior gate assembly 118 includes the first interior gate side arm 122 and the second interior gate side arm 122 extending horizontally to form the interior barrier forward of the central platform assembly 104.

As further shown in FIG. 10, each of the first exterior gate side arm 120, the second exterior gate side arm 120, the first interior gate side arm 122, and the second interior gate side arm 122 is connected via a dual axis hinge configured to enable movement about a first directional axis and a second directional axis. The exterior gate side arms 120 are connected via the dual axis hinges 126, and the interior gate side arms 122 are connected via the dual axis hinges 128. The dual axis hinge 126 may provide rotation of the exterior gate side arm 120 about a first axis X and a second axis Y. The dual axis hinge 128 may provide rotation of the interior gate side arm 122 about the first axis X and the second axis Y. The combination of the first axis X and the second axis Y provides three-dimensional movement of the exterior gate side arm 120 and the interior gate side arm 122, thereby allowing the exterior gate side arm 120 and the interior gate side arm 122 to move upward and rearward from the default closed position. The exterior gate side arm 120 and the interior gate side arm 122 may be configured to articulate up, over, and around a load during operation.

In one embodiment, the dual axis hinge 126 and the dual axis hinge 128 each comprise a first hinge portion providing rotation about a horizontal axis and a second hinge portion providing rotation about a vertical axis. The first hinge portion may be configured to enable the respective gate side arm to pivot upward from the default closed position, while the second hinge portion may be configured to enable the respective gate side arm to swing rearward toward the mezzanine. The combination of the horizontal axis rotation and the vertical axis rotation allows the gate arms to follow a compound path of motion that accommodates loads of varying heights and depths as the loads are delivered to or removed from the central platform assembly 104.

In an example embodiment, the exterior gate side arms 120 and the interior gate side arms 122 are mobilized by springs that assist in the articulating movement of the gate arms during operation. The springs may provide a biasing force that facilitates smooth transition of the gate arms between the closed position and the open position. The dual axis hinge 126 and the dual axis hinge 128 may comprise hydraulic hinges that provide controlled, dampened movement of the respective gate side arms. The hydraulic hinges may regulate the speed at which the exterior gate side arms 120 and the interior gate side arms 122 move between positions, preventing abrupt or uncontrolled motion that could pose safety risks or cause damage to the gate assembly 100. The combination of spring-assisted mobilization and hydraulic hinge control provides a balanced system that enables workers to easily manipulate the gate arms while maintaining predictable and safe movement characteristics.

Each dual axis hinge 126 and each dual axis hinge 128 may comprise a self-closing hinge configured to bias a respective gate side arm to a default closed position. The self-closing hinge may bias the exterior gate side arms 120 and the interior gate side arms 122 back to the default closed position, negating user error and enhancing workplace safety. FIG. 10 illustrates the exterior gate side arms 120 and the interior gate side arms 122 when in the upward, vertical position, allowing full accessibility to and from the central platform assembly 104.

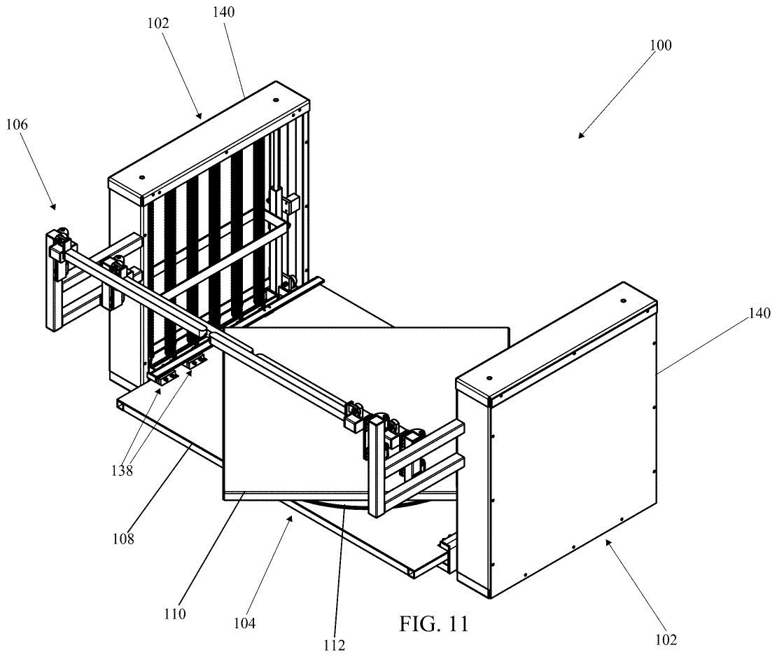

Referring to FIG. 11, a front perspective view of the gate assembly 100 is shown in a gate-closed, platform-lowered position showing rotation of the rotatable upper platform 110. The side support assembly 102 is shown on both the left and right portions of the figure, providing structural support for the overall gate assembly 100 and movement of the central platform assembly 104. The central platform assembly 104 is positioned between the two side support assemblies 102 and includes the slidable platform 108, which extends horizontally. The rotatable upper platform 110 is operably positioned above the slidable platform 108 and is configured to rotate relative to the slidable platform 108. The rotational rolling-element bearing 112 is visible beneath the rotatable upper platform 110, enabling the rotational functionality. The fixed frame assembly 140 is shown within the side support assembly 102, providing a stationary reference structure. The gate arm assembly 106 extends forward of the central platform assembly 104, featuring horizontal members that provide a barrier function.

With continued reference to FIG. 11, the central platform assembly 104 comprises the slidable platform 108 and the rotatable upper platform 110 positioned above the slidable platform 108. The rotatable upper platform 110 is configured to rotate relative to the slidable platform 108. The rotational rolling-element bearing 112 is operably positioned between the slidable platform 108 and the rotatable upper platform 110. The view shows the rotational rolling-element bearing 112 with the rotatable upper platform 110 rotated approximately 45 degrees relative to the slidable platform 108, demonstrating the rotational capability of the rotatable upper platform 110. An upper roller 138 is visible as part of the platform support assembly 114, facilitating the sliding movement of the slidable platform 108.

The rotational capability of the rotatable upper platform 110 allows a worker to spin a load placed thereon to access different portions of the load without requiring the worker to reposition themselves around the central platform assembly 104. For example, when a pallet of goods is delivered to the rotatable upper platform 110, a worker standing at a fixed position adjacent to the gate assembly 100 may rotate the rotatable upper platform 110 to bring different sides of the load within reach, facilitating efficient unloading of materials from multiple sides of the load while the worker remains in a safe, stationary position on the mezzanine.

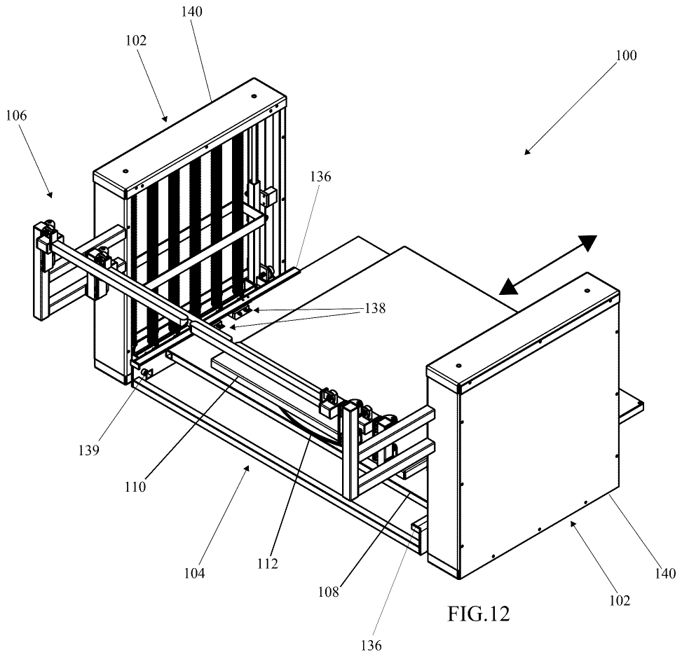

Referring to FIG. 12, a front perspective view of the gate assembly 100 is shown with the slidable platform 108 in a rearward position, illustrating the structural arrangement and relationship between components. The gate assembly 100 includes the side support assembly 102 positioned on each lateral side of the structure, with the central platform assembly 104 extending horizontally between the two side support assemblies 102. The gate arm assembly 106 is mounted near the forward portion of the gate assembly 100, providing a barrier forward of the central platform assembly 104. Each side support assembly 102 comprises the fixed frame assembly 140 that provides structural support for the gate assembly 100.

With continued reference to FIG. 12, the central platform assembly 104 includes the slidable platform 108 and the rotatable upper platform 110 positioned above the slidable platform 108. The rotational rolling-element bearing 112 is operably positioned between the slidable platform 108 and the rotatable upper platform 110, enabling the rotatable upper platform 110 to rotate relative to the slidable platform 108. The rotational rolling-element bearing 112 appears as a slewing ring bearing or turntable mechanism that supports rotational movement.

As further shown in FIG. 12, a guide rail 136 extends along the central platform assembly 104, providing a track for facilitating horizontal sliding movement of the slidable platform 108. The upper roller 138 is visible as part of the platform support assembly 114, engaging with the guide rail 136 to enable the sliding movement of the slidable platform 108 relative to the side support assemblies 102. The central platform assembly 104 may further comprise the platform support assembly 114 including the guide rail 136 extending along each side of the central platform assembly 104, the upper roller 138, and lower rollers 139 engaging with the guide rail 136 to enable horizontal sliding movement of the slidable platform 108 relative to the first side support assembly 102 and the second side support assembly 102.

The central platform assembly 104 may be configured to slide horizontally rearward relative to the first side support assembly 102 and the second side support assembly 102 via a first-side slide mechanism and a parallel second-side slide mechanism. The view in FIG. 12 demonstrates the spatial relationship between the side support assemblies 102 and the central platform assembly 104, illustrating how the central platform assembly 104 is supported between the two side support assemblies 102 while the gate arm assembly 106 provides a protective barrier at the forward portion of the gate assembly 100. The view also emphasizes the horizontal sliding capability of the slidable platform 108 and shows the slidable platform 108 in a rear maximum slide position.

The horizontal sliding capability of the slidable platform 108 provides operational advantages for workers unloading materials from the central platform assembly 104. When the slidable platform 108 is moved rearward, the load positioned on the rotatable upper platform 110 is correspondingly displaced toward the interior of the mezzanine, bringing the load closer to workers standing on the elevated platform. This rearward positioning allows workers to reach items on the load more easily without leaning over the gate arm assembly 106 or extending beyond safe working boundaries. The combination of the rearward sliding movement and the rotational capability of the rotatable upper platform 110 enables workers to access all sides of a load while maintaining a stable, ergonomic working position on the mezzanine surface.

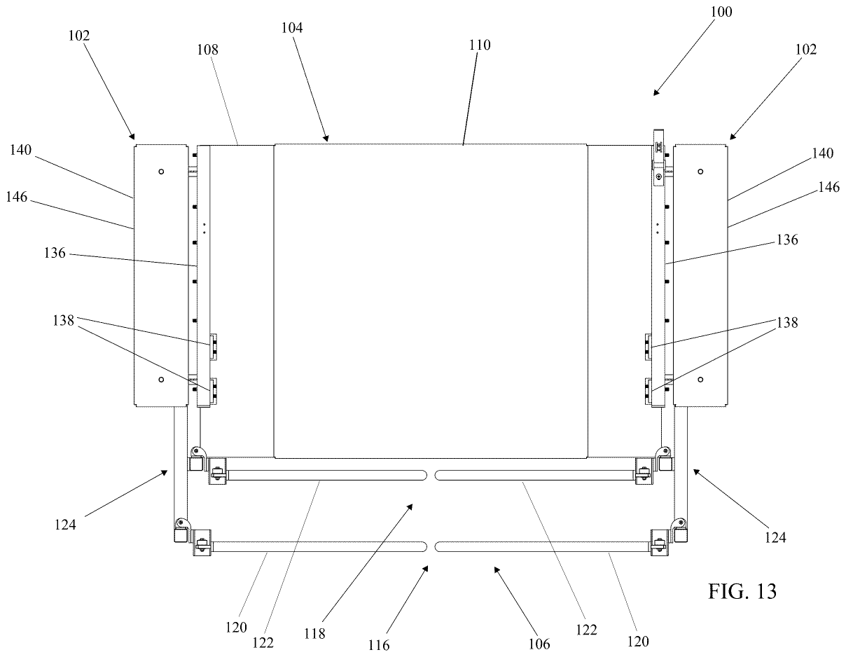

Referring to FIG. 13, a top plan view of the gate assembly 100 is shown in a gate-closed position. The gate assembly 100 includes the side support assembly 102 positioned on each lateral side, with the central platform assembly 104 extending horizontally between the two side support assemblies 102. The gate arm assembly 106 is mounted near the top of each side support assembly 102 and provides a horizontal barrier forward of the central platform assembly 104.

Each side support assembly 102 comprises the fixed frame assembly 140 that provides structural support for the gate assembly 100. The fixed frame assembly 140 includes the top support member 146 at the upper portion. The side support assembly 102 houses the internal components that enable vertical movement of the central platform assembly 104.

With continued reference to FIG. 13, the central platform assembly 104 includes the slidable platform 108 and the rotatable upper platform 110 positioned above the slidable platform 108. The rotatable upper platform 110 is configured to rotate relative to the slidable platform 108. Guide rails 136 extends along the central platform assembly 104 on each side, providing opposing tracks for facilitating horizontal sliding movement of the slidable platform 108. The upper roller 138 is visible as part of the platform support assembly 114, engaging with the guide rail 136 to enable the sliding movement of the slidable platform 108 relative to the side support assemblies 102.

The gate arm assembly 106 includes the exterior gate assembly 116 and the interior gate assembly 118 on each side. The exterior gate assembly 116 includes opposing exterior gate side arms 120, and the interior gate assembly 118 includes opposing interior gate side arms 122. Each gate arm assembly 106 is supported by the side support structure 124 that is affixed to the respective fixed frame assembly 140 of the side support assembly 102. The exterior gate side arms 120 and the interior gate side arms 122 extend horizontally to form an exterior barrier and an interior barrier forward of the central platform assembly 104, providing fall protection at the delivery opening.

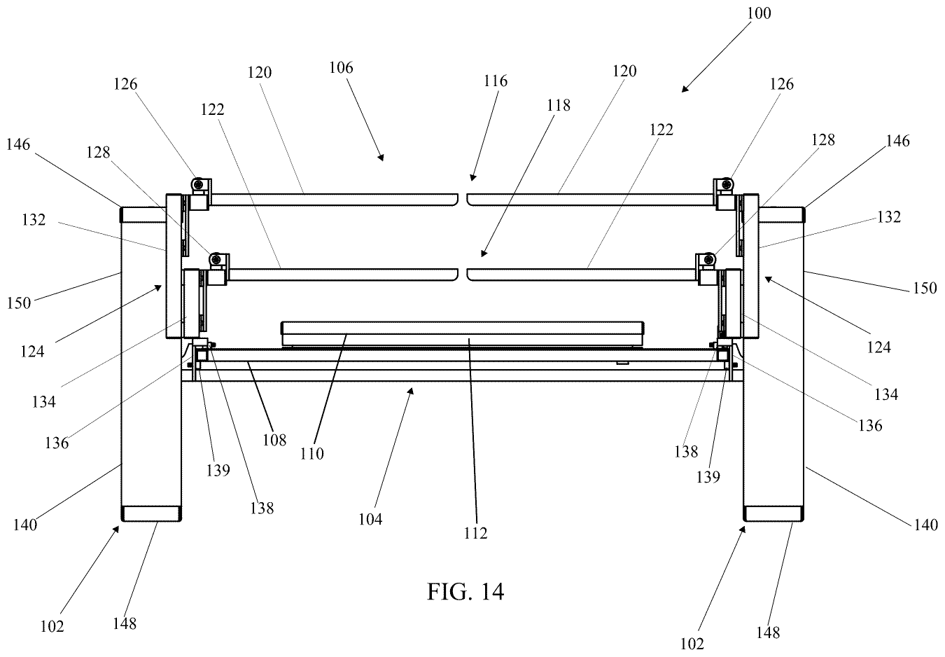

Referring to FIG. 14, a front elevation view of the gate assembly 100 is shown in a gate-closed, platform-elevated default position. The gate assembly 100 includes the side support assembly 102 positioned on each lateral side, with the central platform assembly 104 extending horizontally between the two side support assemblies 102. The gate arm assembly 106 is mounted near the top of each side support assembly 102 and provides a horizontal barrier forward of the central platform assembly 104.

Each side support assembly 102 comprises the fixed frame assembly 140 that provides structural support for the gate assembly 100 and supports the central platform assembly 104 throughout its path of motion. The fixed frame assembly 140 includes the top support member 146 at the upper portion and the base support member 148 at the lower portion. The forward member 150 extends vertically between the top support member 146 and the base support member 148 on each side support assembly 102.

With continued reference to FIG. 14, the central platform assembly 104 includes the slidable platform 108 and the rotatable upper platform 110 positioned above the slidable platform 108. The rotational rolling-element bearing 112 is operably positioned between the slidable platform 108 and the rotatable upper platform 110, enabling the rotatable upper platform 110 to rotate relative to the slidable platform 108. As described previously, the rotational rolling-element bearing 112 may comprise a slewing ring bearing. The guide rail 136 extends along the central platform assembly 104 on each side, providing tracks for facilitating horizontal sliding movement of the slidable platform 108. The central platform assembly 104 may further comprise the platform support assembly 114, including the guide rails 136 extending along each side of the central platform assembly 104. The upper rollers 138 and a lower rollers 139 are visible and are integrated within each guide rail 136, engaging with the slidable platform 108 to enable the sliding movement of the slidable platform 108 relative to the side support assemblies 102. The upper rollers 138 and the lower rollers 139 engage with the guide rails 136 to enable horizontal sliding movement of the slidable platform 108 relative to the first side support assembly 102 and the second side support assembly 102.

As further shown in FIG. 14, the gate arm assembly 106 includes the exterior gate assembly 116 and the interior gate assembly 118 staggered from front to rear. The exterior gate assembly 116 includes opposing exterior gate side arms 120, and the interior gate assembly 118 includes opposing interior gate side arms 122. The gate arm assembly 106 is supported by the side support structures 124, which are affixed to the respective fixed frame assemblies 140 of the side support assemblies 102. Each side support structure 124 includes the exterior vertical member 132 and the interior vertical member 134 that extend vertically to support the respective exterior gate side arm 120 and the interior gate side arm 122. The exterior gate side arms 120 are connected via the dual axis hinge 126, and the interior gate side arms 122 are connected via the dual axis hinge 128. The dual axis hinge 126 and the dual axis hinge 128 enable the respective exterior gate side arm 120 and the interior gate side arm 122 to move about a first directional axis and a second directional axis, allowing the gate arms to articulate upward and rearward from a default, lowered and closed position.

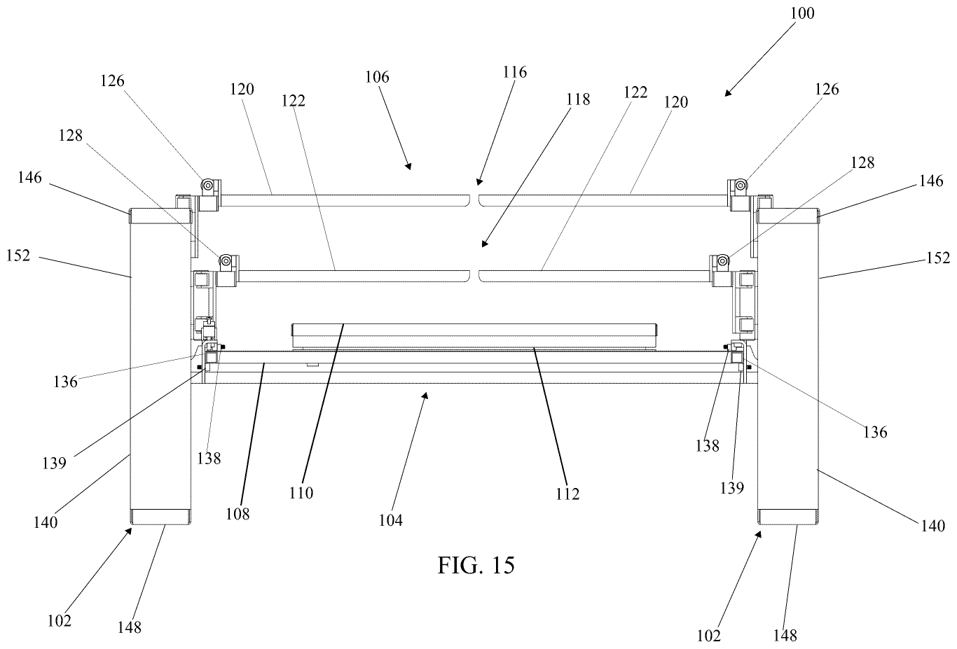

Referring to FIG. 15, a rear elevation view of the gate assembly 100 is shown in a gate-closed, platform-elevated default position. The gate assembly 100 includes the side support assembly 102 positioned on each lateral side, with the central platform assembly 104 extending horizontally between the two side support assemblies 102. The gate arm assembly 106 is mounted near the top of each side support assembly 102 and provides a horizontal barrier forward of the central platform assembly 104.

Each side support assembly 102 comprises the fixed frame assembly 140 that provides structural support for the gate assembly 100. The fixed frame assembly 140 includes the top support member 146 at the upper portion and the base support member 148 at the lower portion. The rear member 152 extends vertically between the top support member 146 and the base support member 148 on each side support assembly 102.

With continued reference to FIG. 15, the central platform assembly 104 includes the slidable platform 108 and the rotatable upper platform 110 positioned above the slidable platform 108. The rotational rolling-element bearing 112 is operably positioned between the slidable platform 108 and the rotatable upper platform 110, enabling the rotatable upper platform 110 to rotate relative to the slidable platform 108. Guide rails 136 extend along the central platform assembly 104 on each side, providing tracks for facilitating horizontal sliding movement of the slidable platform 108. The upper roller 138 and the lower roller 139 are visible and are integrated within each guide rail 136, engaging with the slidable platform 108 to enable the sliding movement of the slidable platform 108 relative to the side support assemblies 102.

The gate arm assembly 106 includes the exterior gate assembly 116 and the interior gate assembly 118 staggered from front to rear. The exterior gate assembly 116 includes opposing or mirrored exterior gate side arms 120, and the interior gate assembly 118 includes opposing or mirrored interior gate side arms 122. The exterior gate side arms 120 are connected via the dual axis hinge 126, and the interior gate side arms 122 are connected via the dual axis hinge 128. The dual axis hinge 126 and the dual axis hinge 128 enable the respective exterior gate side arm 120 and the interior gate side arm 122 to move about a first directional axis and a second directional axis, allowing the gate arms to articulate upward and rearward from a default, downward and forward closed position. The exterior gate side arms 120 and the interior gate side arms 122 extend horizontally to form an exterior barrier and an interior barrier forward of the central platform assembly 104, providing fall protection at the delivery opening.

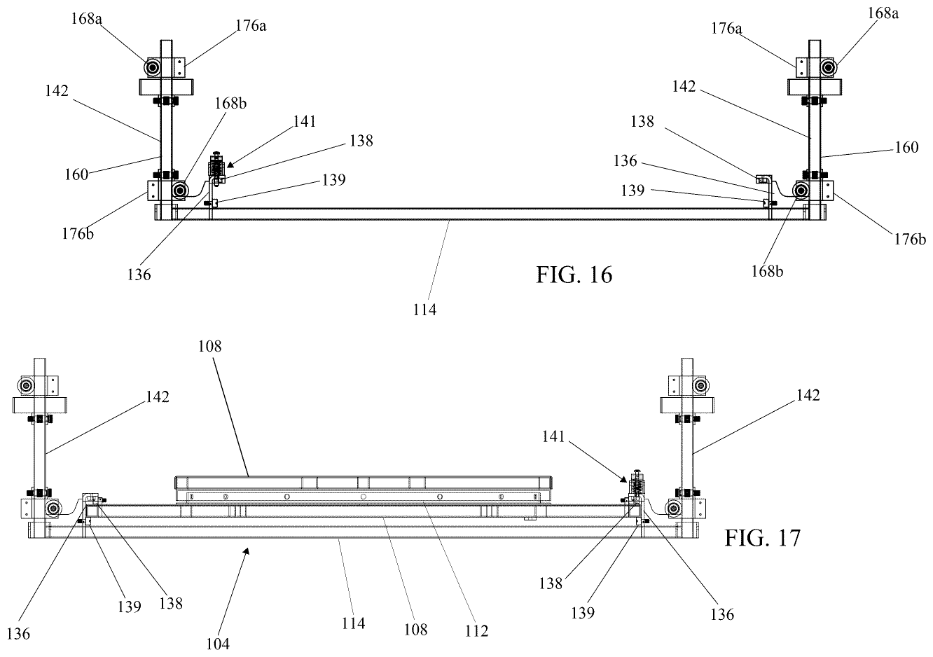

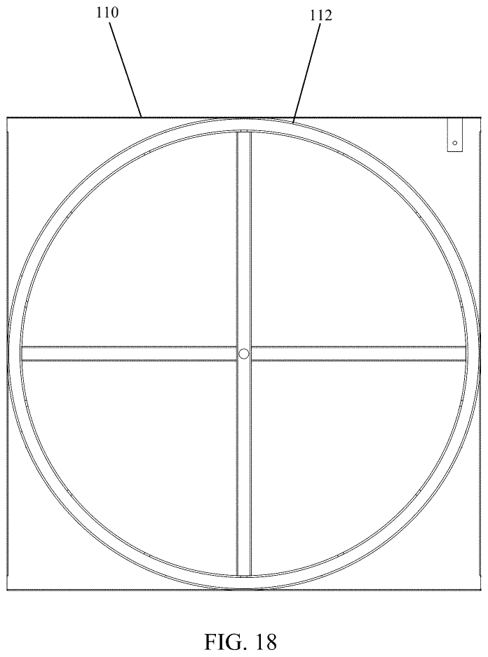

Referring to FIG. 16 and FIG. 17, views of the gate assembly 100 are shown illustrating the central platform assembly 104 attached to opposing movable vertical frames 142 and associated support components. The central platform assembly 104 includes the slidable platform 108 and the platform support assembly 114 that provides structural support beneath the slidable platform 108.

FIG. 16 illustrates an elevation view of the platform support assembly 114 attached to the movable vertical frames 142 without the slidable platform 108 and the rotatable upper platform 110. The platform support assembly 114 is fixedly attached at each side to a respective movable vertical frame 142. The platform support assembly 114 includes the guide rail 136 extending along each side of the central platform assembly 104. The guide rails 136 provide tracks for facilitating horizontal sliding movement of the slidable platform 108. The upper rollers 138 and the lower rollers 139 are integrated within the platform support assembly 114 and guide rails 136 to enable the sliding movement of the slidable platform 108 relative to the side support assemblies 102. A lock 141 is positioned on the platform support assembly 114, configured to secure the slidable platform 108 in a desired position.

With continued reference to FIG. 16, the movable vertical frame 142 is shown on each side of the central platform assembly 104. Each movable vertical frame 142 includes a first deck guide 160 that is configured to couple with vertical guide rods within the fixed frame assembly 140, allowing the movable vertical frame 142 to translate vertically. A first-side cam follower 168a is positioned at an upper location and a first-side cam follower 168b is positioned at a lower location on the movable vertical frame 142, configured to translate along corresponding cam guides within the fixed frame assembly 140. Similarly, a first side guide block 176a is positioned at an upper location and a first side guide block 176b is positioned at a lower location, providing additional linear vertical guidance for the vertical movement of the movable vertical frame 142. The first-side cam follower 168a, the first-side cam follower 168b, the first side guide block 176a, and the first side guide block 176b may provide additional guidance during vertical translation of the movable vertical frame 142.

Referring to FIG. 17, an elevation view of the central platform assembly 104 is shown including the slidable platform 108 and the rotatable upper platform 110 attached to the movable vertical frames 142 of FIG. 16. As described previously, the central platform assembly 104 comprises the slidable platform 108 and the rotatable upper platform 110 positioned above the slidable platform 108. The rotatable upper platform 110 is configured to rotate relative to the slidable platform 108. The rotational rolling-element bearing 112 is operably positioned between the slidable platform 108 and the rotatable upper platform 110, enabling rotational functionality of the rotatable upper platform 110 relative to the slidable platform 108. In some cases, the rotational rolling-element bearing 112 comprises a slewing ring bearing that supports rotational movement of loads placed on the rotatable upper platform 110.

With continued reference to FIG. 17, the arrangement demonstrates how the central platform assembly 104 is supported between the two movable vertical frames 142, with the platform support assembly 114 providing the structural framework for the sliding and rotating capabilities of the platform components. The lock 141 may be engaged to secure the slidable platform 108 at a desired horizontal position along the guide rails 136. The first deck guide 160 on each movable vertical frame 142 couples with the vertical guide rods of the fixed frame assembly 140 to enable controlled vertical movement of the central platform assembly 104 between the elevated position and the lowered position. The first-side cam follower 168a and the first-side cam follower 168b translate along the cam guides within the fixed frame assembly 140, while the first side guide block 176a and the first side guide block 176b provide supplementary guidance to maintain alignment during vertical translation of the movable vertical frame 142.

The lock 141 may comprise a spring-loaded pin that engages a slot on the slidable platform 108 and is manually operated to selectively secure or release the slidable platform 108 for horizontal movement along the guide rails 136.

Referring to FIG. 18, a bottom plan view of the rotatable upper platform 110 is shown with the rotational rolling-element bearing 112 attached thereto. The rotatable upper platform 110 is shown as a rectangular platform. The rotational rolling-element bearing 112 is visible as a circular ring mechanism positioned beneath the rotatable upper platform 110, appearing as a circle that indicates the slewing ring bearing or turntable arrangement. The rotational rolling-element bearing 112 enables the rotatable upper platform 110 to rotate relative to the underlying carriage style slidable platform. Cross-members extend across the rotatable upper platform 110. The rectangular frame surrounding the rotatable upper platform 110 provides structural support and defines the boundary of the platform assembly. The bottom plan view demonstrates the rectangular configuration of the rotatable upper platform 110 and the positioning of the rotational rolling-element bearing 112 that facilitates rotational movement of loads placed on the platform surface.

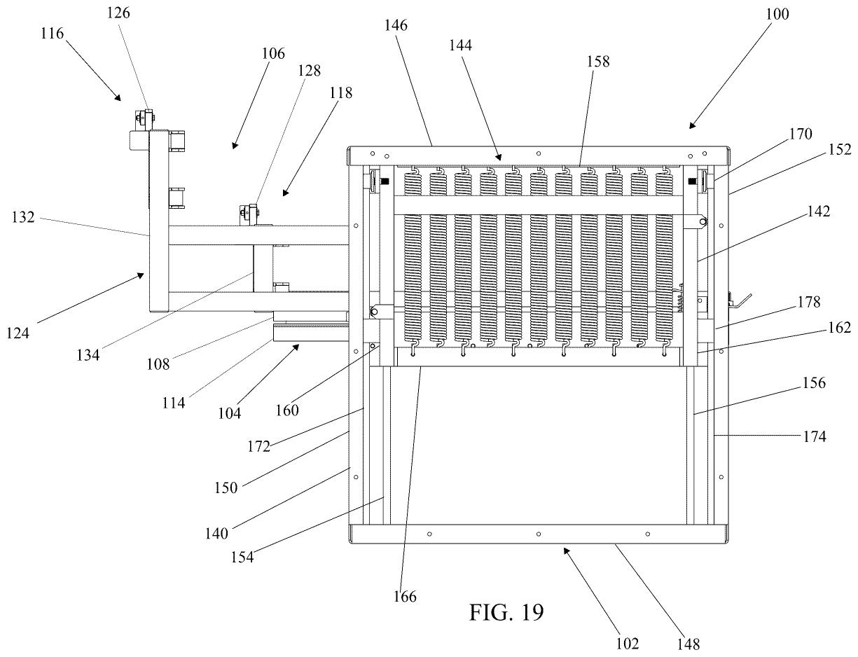

Referring to FIG. 19, a first side elevation view of the gate assembly 100 is shown in the platform-elevated default position, illustrating the internal components and structural arrangement of the side support assembly 102. The gate assembly 100 includes the side support assembly 102, the central platform assembly 104, and the gate arm assembly 106. The side support assembly 102 comprises the fixed frame assembly 140 and the movable vertical frame 142.

The fixed frame assembly 140 includes the top support member 146 at the upper portion and the base support member 148 at the lower portion. The forward member 150 and the rear member 152 extend vertically between the top support member 146 and the base support member 148, forming the structural rectangular framework of the side support assembly 102. The fixed frame assembly 140 further includes a first guide rod 154 and a second guide rod 156 extending vertically and parallel between the top support member 146 and the base support member 148. The first guide rod 154 and the second guide rod 156 may be affixed between the base support member 148 and the top support member 146. A first spring connection member 158 is positioned near the top support member 146, providing upper attachment points for the plurality of springs 144.

With continued reference to FIG. 19, the fixed frame assembly 140 also includes first side parallel vertical cam guides 172 positioned and integrated along the forward member 150 and second side parallel vertical cam guides 174 positioned and integrated along the rear member 152. The first side parallel vertical cam guides 172 and the second side parallel vertical cam guides 174 provide vertical parallel tracks for guiding movement of the movable vertical frame 142. The forward member 150 may include a pair of vertically parallel interior forward cam guides along its vertical length, and the rear member 152 may include a pair of vertically parallel interior rear cam guides along its vertical length.

The movable vertical frame 142 includes the first deck guide 160 and a second deck guide 162, which are configured to couple with the first guide rod 154 and the second guide rod 156 respectively, enabling vertical movement of the movable vertical frame 142 relative to the fixed frame assembly 140. The first deck guide 160 and the second deck guide 162 may be affixed together by a horizontal structural member 164. A second spring connection member 166 is positioned at a lower portion of the movable vertical frame 142, providing lower attachment points for the plurality of springs 144. The second spring connection member 166 may be horizontally affixed between the bottom portions of the first deck guide 160 and the second deck guide 162, below the horizontal structural member 164.

As further shown in FIG. 19, the plurality of springs 144 extends between the first spring connection member 158 and the second spring connection member 166, creating elastic tension between the fixed frame assembly 140 and the movable vertical frame 142 that counters downward movement and enables self-leveling functionality. As described previously, the central platform assembly 104 is configured to move vertically between an elevated position and a lowered position responsive to a load placed thereon.

In one embodiment, each spring of the plurality of springs 144 may comprise a spring having a tension of approximately 100 pounds at full extension. The full extension length of each spring may be approximately 26 inches. As an example, the diameter of each spring is preferably no greater than 2 inches to accommodate the spacing constraints within the fixed frame assembly 140. The number and arrangement of springs within each side support assembly 102 may be selected based on the anticipated load capacity of the central platform assembly 104 and the desired self-leveling characteristics of the gate assembly 100.

The central platform assembly 104 extends horizontally from the side support assembly 102 and includes the slidable platform 108 and the platform support assembly 114 positioned beneath the slidable platform 108 to provide structural support. The gate arm assembly 106 includes the exterior gate assembly 116 and the interior gate assembly 118. The side support structure 124 provides mounting support for the gate arms and includes the exterior vertical member 132 and the interior vertical member 134 that extend vertically to support the respective gate arms. The exterior gate assembly 116 and the interior gate assembly 118 are connected via the dual axis hinge 126 and the dual axis hinge 128 respectively, enabling the gate arms to move about a first directional axis and a second directional axis, allowing articulation upward and rearward from a default closed position.

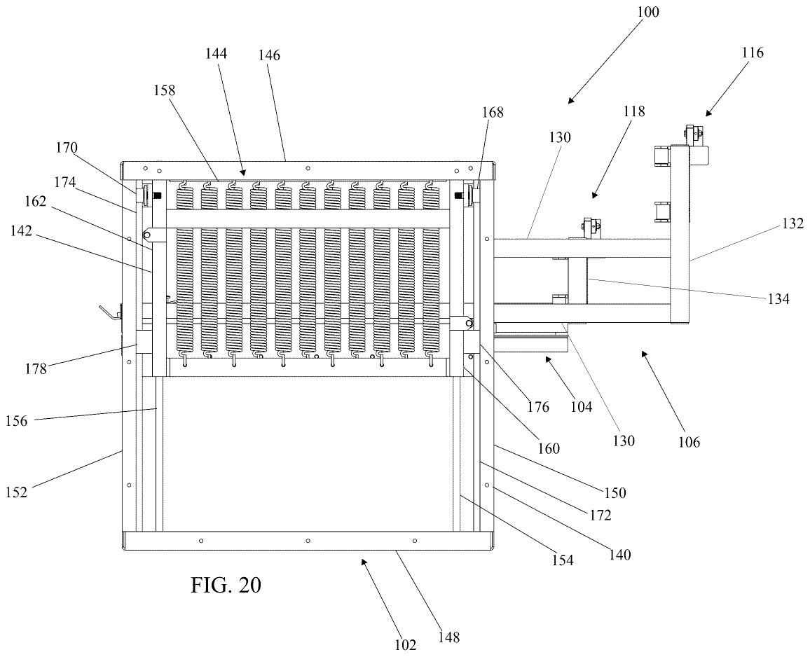

Referring to FIG. 20, a second side elevation view of the gate assembly 100 is shown in the platform-elevated default position, illustrating the internal components and structural arrangement of the side support assembly 102 from a mirrored perspective. The gate assembly 100 includes the side support assembly 102, the central platform assembly 104, and the gate arm assembly 106. The side support assembly 102 comprises the fixed frame assembly 140 and the movable vertical frame 142.

The fixed frame assembly 140 includes the top support member 146 at the upper portion and the base support member 148 at the lower portion. The forward member 150 and the rear member 152 extend vertically between the top support member 146 and the base support member 148, forming the structural rectangular framework of the side support assembly 102. The fixed frame assembly 140 further includes the first guide rod 154 and the second guide rod 156 extending vertically and parallel between the top support member 146 and the base support member 148. The first spring connection member 158 is positioned near the top support member 146, providing attachment points for the plurality of springs 144.

With continued reference to FIG. 20, the fixed frame assembly 140 also includes the first side parallel vertical cam guides 172 positioned along the forward member 150 and the second side parallel vertical cam guides 174 positioned along the rear member 152, providing vertical tracks for guiding movement of the movable vertical frame 142.

The movable vertical frame 142 includes the first deck guide 160 and the second deck guide 162, which are configured to couple with the first guide rod 154 and the second guide rod 156 respectively, enabling vertical movement of the movable vertical frame 142 relative to the fixed frame assembly 140. The movable vertical frame 142 further includes first side cam followers 168 configured to translate along the first side parallel vertical cam guides 172, and the second side cam followers 170 configured to translate along the second side parallel vertical cam guides 174. First side guide blocks 176 and the second side guide blocks 178 provide additional guidance for the vertical movement of the movable vertical frame 142.

The plurality of springs 144 extends between the first spring connection member 158 and the movable vertical frame 142, creating elastic tension between the fixed frame assembly 140 and the movable vertical frame 142 that counters downward movement and enables self-leveling functionality. The central platform assembly 104 extends horizontally from the side support assembly 102 and is supported by the movable vertical frame 142. As described previously, the central platform assembly 104 extends between and is operably connected to the first movable vertical frame 142 and the second movable vertical frame 142.

As further shown in FIG. 20, the gate arm assembly 106 includes the exterior gate assembly 116 and the interior gate assembly 118. The gate arm assembly 106 is supported by a structure that includes the horizontal members 130, the exterior vertical member 132, and the interior vertical member 134 that extend to support the respective gate arms. The exterior vertical member 132 and the interior vertical member 134 provide mounting support for the exterior gate assembly 116 and the interior gate assembly 118 respectively. The exterior gate assembly 116 includes opposing exterior gate side arms 120, and the interior gate assembly 118 includes opposing interior gate side arms 122. Each of the exterior gate side arms 120 and the interior gate side arms 122 is connected via a dual axis hinge configured to enable movement about a first directional axis and a second directional axis.

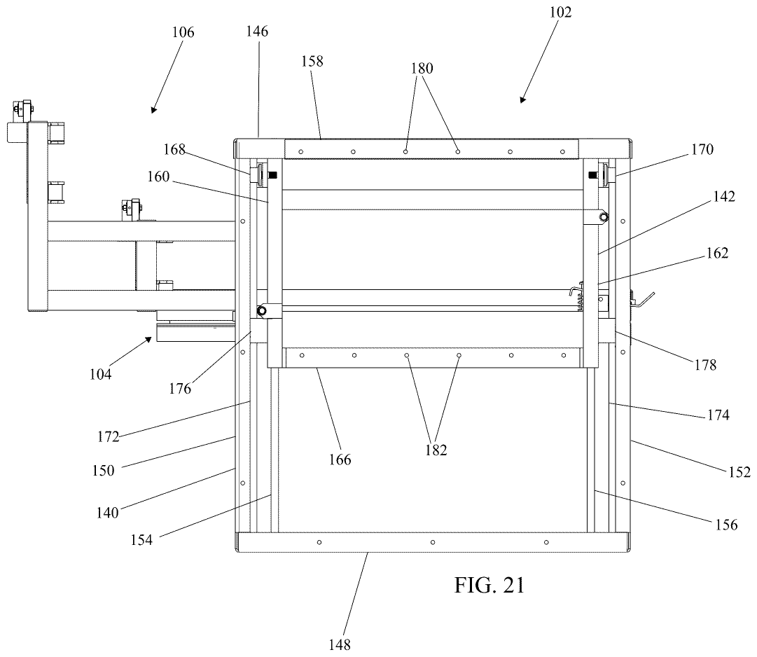

Referring to FIG. 21, a first side elevation view of a side support assembly 102 is shown with the movable vertical frame 142 in an elevated position. The view excludes the plurality of springs 144 to reveal the internal structural components and their arrangement within the side support assembly 102. FIG. 21 illustrates the movable vertical frame 142 when in the upward, elevated position corresponding to an unloaded state of the central platform assembly 104.

The side support assembly 102 includes the fixed frame assembly 140, which provides structural support for the movable vertical frame 142. As described previously, the fixed frame assembly 140 comprises the top support member 146 at the upper portion and the base support member 148 at the lower portion, with the forward member 150 and the rear member 152 extending vertically between the top support member 146 and the base support member 148 to form a rectangular framework. The first guide rod 154 and the second guide rod 156 are positioned within the fixed frame assembly 140, extending vertically between the top support member 146 and the base support member 148 to provide vertical guidance for the movable vertical frame 142.

With continued reference to FIG. 21, the first spring connection member 158 is located near the top support member 146 and includes a plurality of upper connection points 180 that provide upper attachment points for the plurality of springs 144. The plurality of upper connection points 180 may appear as a series of apertures or attachment locations along the length of the first spring connection member 158. The fixed frame assembly 140 also includes the first side parallel vertical cam guides 172 positioned along the forward member 150 and the second side parallel vertical cam guides 174 positioned along the rear member 152, providing vertical tracks for guiding movement of the movable vertical frame 142.

The movable vertical frame 142 includes the first deck guide 160 and the second deck guide 162, which are configured to couple with the first guide rod 154 and the second guide rod 156 respectively, enabling vertical movement of the movable vertical frame 142 relative to the fixed frame assembly 140. The second spring connection member 166 is positioned at a lower portion of the movable vertical frame 142 and includes a plurality of lower connection points 182 that provide lower attachment points for the plurality of springs 144 on the movable vertical frame 142. The plurality of lower connection points 182 may appear as a series of apertures along the length of the second spring connection member 166, corresponding to the plurality of upper connection points 180 on the first spring connection member 158.

As further shown in FIG. 21, the first side cam followers 168 and the second side cam followers 170 are configured to translate along the first side parallel vertical cam guides 172 and the second side parallel vertical cam guides 174 respectively. The first side guide blocks 176 and the second side guide blocks 178 provide additional guidance for the movable vertical frame 142 during vertical translation. The movable vertical frame 142 may include a forward lower pair of cam followers, a forward upper pair of cam followers, a rear lower pair of cam followers, and a rear upper pair of cam followers positioned at upper and lower locations to facilitate controlled vertical movement along the corresponding cam guides within the fixed frame assembly 140.

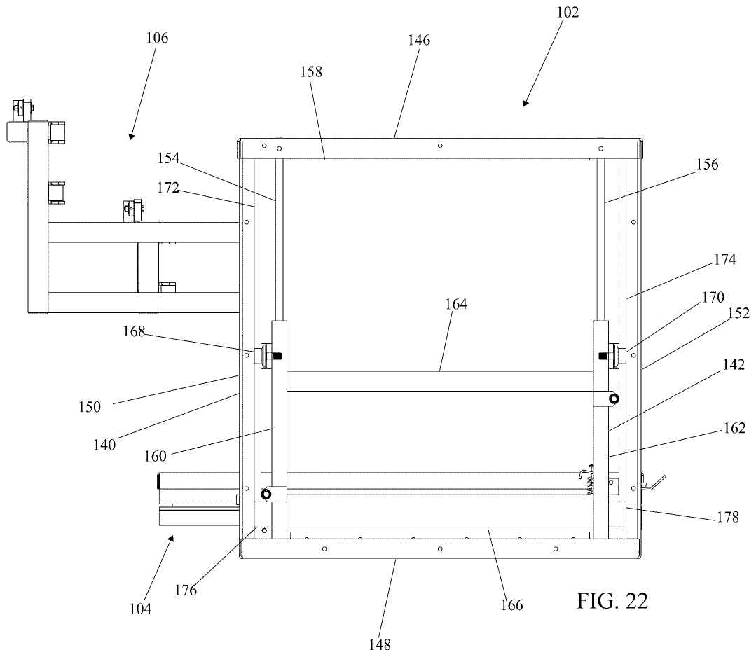

Referring to FIG. 22, a first side elevation view of the side support assembly 102 of FIG. 21 is shown with the movable vertical frame 142 in a lowered position. The view excludes the plurality of springs 144 to reveal the internal structural components. FIG. 22 illustrates the movable vertical frame 142 when in the downward, lowered position corresponding to a loaded state of the central platform assembly 104.

With continued reference to FIG. 22, the fixed frame assembly 140 comprises the top support member 146 at the upper portion and the base support member 148 at the lower portion, with the forward member 150 and the rear member 152 extending vertically between the top support member 146 and the base support member 148 to form the rectangular framework. The first guide rod 154 and the second guide rod 156 extend vertically between the top support member 146 and the base support member 148 to provide vertical guidance for the movable vertical frame 142.

The first spring connection member 158 is located near the top support member 146 and includes the plurality of upper connection points 180 that provide attachment points for the plurality of springs 144. The movable vertical frame 142 includes the first deck guide 160 and the second deck guide 162, which are configured to couple with the first guide rod 154 and the second guide rod 156 respectively. The horizontal structural member 164 extends between and connects the first deck guide 160 and the second deck guide 162, providing structural support to the movable vertical frame 142. The second spring connection member 166 is positioned at a lower portion of the movable vertical frame 142 and includes the plurality of lower connection points 182 that provide attachment points for the plurality of springs 144.

As further shown in FIG. 22, the first side cam followers 168 are configured to translate along the first side parallel vertical cam guides 172, and the second side cam followers 170 are configured to translate along the second side parallel vertical cam guides 174. The first side guide blocks 176 and the second side guide blocks 178 provide additional guidance for the movable vertical frame 142 during vertical translation and prevent side loading. The central platform assembly 104 extends from the side support assembly 102 and is operably connected to the movable vertical frame 142, allowing the central platform assembly 104 to move vertically between the elevated position and the lowered position.

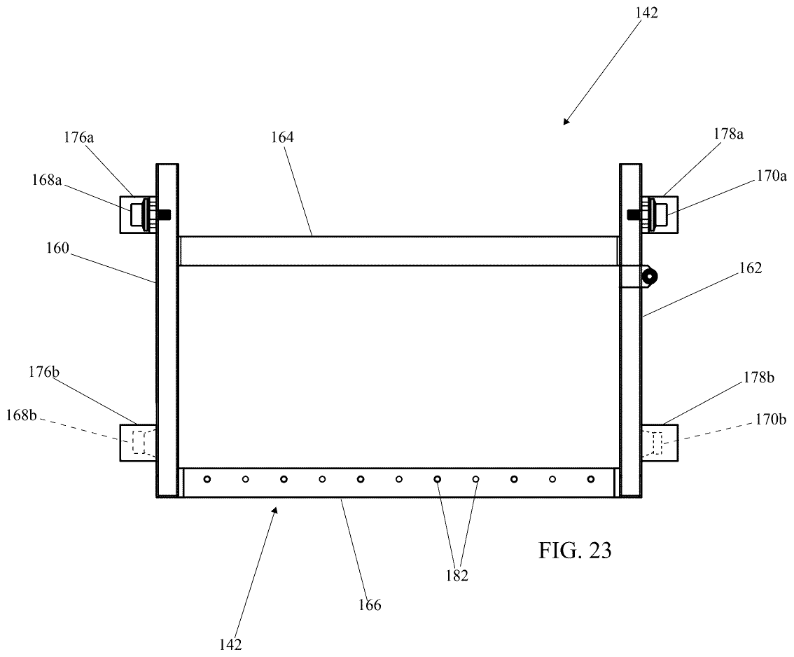

Referring to FIG. 23, a front elevation view of the movable vertical frame 142 is shown, illustrating the structural arrangement and components that enable vertical translation within the fixed frame assembly 140. The movable vertical frame 142 includes the first deck guide 160 positioned on a first side and the second deck guide 162 positioned on a second side. The first deck guide 160 and the second deck guide 162 are configured to couple with corresponding vertical guide rods within the fixed frame assembly 140 to enable vertical movement of the movable vertical frame 142.

The horizontal structural member 164 extends horizontally between and connects the first deck guide 160 and the second deck guide 162, providing structural support and rigidity to the movable vertical frame 142. The second spring connection member 166 is positioned at a lower portion of the movable vertical frame 142, extending horizontally below the horizontal structural member 164. The second spring connection member 166 includes the plurality of lower connection points 182, which may appear as a series of apertures along the length of the second spring connection member 166. The plurality of lower connection points 182 provide lower attachment points for the plurality of springs 144 that create elastic tension between the fixed frame assembly 140 and the movable vertical frame 142.

With continued reference to FIG. 23, the movable vertical frame 142 includes cam followers and block followers positioned at upper and lower locations on each side to facilitate controlled vertical movement along corresponding cam guides within the fixed frame assembly 140. On the first side, the first-side cam follower 168a is positioned at an upper location and the first-side cam follower 168b is positioned at a lower location. The first side cam followers 168a and 168b are configured to each translate along the opposing respective vertical cam guides 172 within the fixed frame assembly 140.

On the second side, a second side cam follower 170a is positioned at an upper location and a second side cam follower 170b is positioned at a lower location. The second side cam followers 170a and 170b are configured to translate along the opposing respective vertical cam guides 174 within the fixed frame assembly 140. As described previously, each of the first movable vertical frame 142 and the second movable vertical frame 142 may further comprise cam followers configured to translate along the first side parallel vertical cam guides 172 and the second side parallel vertical cam guides 174.

As further shown in FIG. 23, the movable vertical frame 142 includes block followers that provide supplementary guidance during vertical translation. The first side guide block 176a is positioned at an upper location at the same elevation as the first-side cam follower 168a, and the first side guide block 176b is positioned at a lower location at the same elevation as the first-side cam follower 168b on the first side. Correspondingly, a second side guide block 178a is positioned at an upper location at the same elevation as the second side cam follower 170a, and a second side guide block 178b is positioned at a lower location at the same elevation as the second side cam follower 170b on the second side. The first side guide blocks 176 and the second side guide blocks 178 are configured to provide additional guidance during vertical translation of the movable vertical frame 142.

The first-side cam follower 168b and the second side cam follower 170b may be shown in dashed lines in FIG. 23, indicating their positioning behind the respective first side guide block 176b and the second side guide block 178b. Each cam follower may be paired with a corresponding block follower that is configured to fit with the fixed frame assembly 140 respective parallel vertical cam guides. The first side cam followers 168 and the first side guide blocks 176 are positioned at upper and lower locations on the movable vertical frame 142, and the second side cam followers 170 and the second side guide blocks 178 are positioned at upper and lower locations on the movable vertical frame 142. This arrangement of cam followers and block followers at both upper and lower locations on each side of the movable vertical frame 142 provides stable and controlled vertical translation of the central platform assembly 104 between the elevated position and the lowered position.

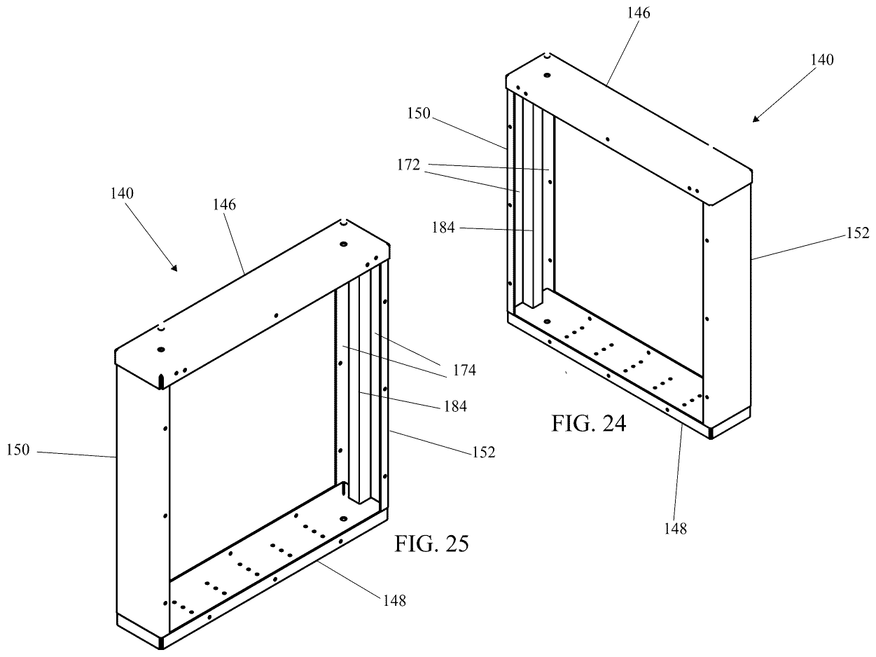

Referring to FIG. 24 and FIG. 25, first and second perspective views of the fixed frame assembly 140 are shown, illustrating the structural arrangement and components that form the stationary framework of the side support assembly 102. The fixed frame assembly 140 includes the top support member 146 positioned at the upper portion and the base support member 148 positioned at the lower portion, forming the horizontal boundaries of the rectangular framework. The forward member 150 and the rear member 152 extend vertically between the top support member 146 and the base support member 148, completing the rectangular structural framework of the fixed frame assembly 140.

With continued reference to FIG. 24 and FIG. 25, the fixed frame assembly 140 includes the first side parallel vertical cam guides 172 positioned along the forward member 150 and the second side parallel vertical cam guides 174 positioned along the rear member 152. The first side parallel vertical cam guides 172 and the second side parallel vertical cam guides 174 provide vertical tracks for guiding movement of the movable vertical frame 142 within the fixed frame assembly 140. As described previously, the first side cam followers 168 are configured to translate along the first side parallel vertical cam guides 172, and the second side cam followers 170 are configured to translate along the second side parallel vertical cam guides 174.

As further shown in FIG. 24 and FIG. 25, a dividing column 184 is positioned within the interior of the fixed frame assembly 140, extending vertically between the top support member 146 and the base support member 148. The dividing column 184 provides structural support and separation within the frame structure. The dividing column 184 divides the first side parallel vertical cam guides 172, and a second dividing column 184 divides the second side parallel vertical cam guides 174. The dividing columns 184 may enhance the structural rigidity of the fixed frame assembly 140 while maintaining the parallel vertical cam guides in proper alignment for guiding the cam followers during vertical translation of the movable vertical frame 142.

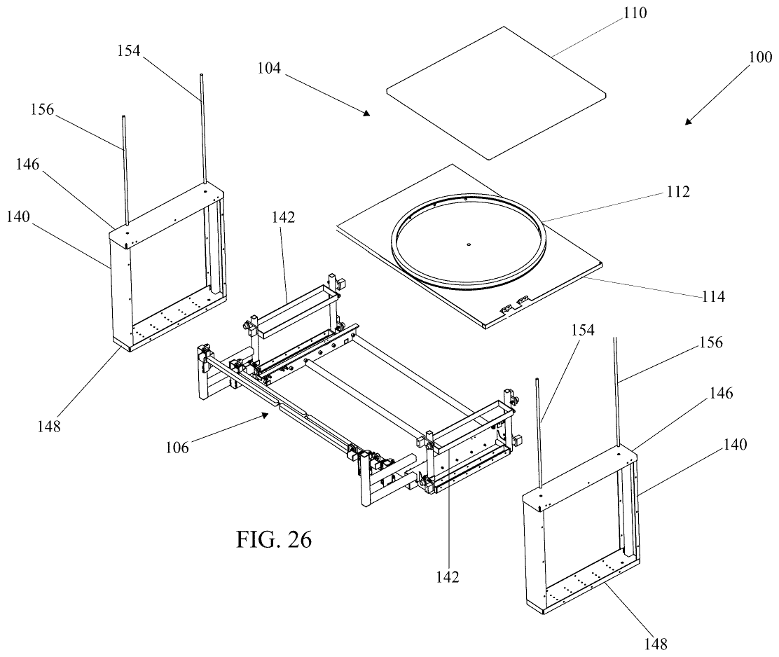

Referring to FIG. 26, an exploded view of the gate assembly 100 is shown, illustrating the relationship between the various components of the central platform assembly 104 and the supporting structures. The exploded view depicts the rotatable upper platform 110 positioned above the rotational rolling-element bearing 112, which appears as a circular slewing ring bearing arrangement. As described previously, the rotational rolling-element bearing 112 is configured to enable the rotatable upper platform 110 to rotate relative to the underlying platform support assembly 114. The platform support assembly 114 is shown beneath the rotational rolling-element bearing 112, providing structural support for the central platform assembly 104.

With continued reference to FIG. 26, the central platform assembly 104 extends between and is operably connected to the first movable vertical frame 142 and the second movable vertical frame 142. Each fixed frame assembly 140 includes the top support member 146 extending vertically upward and the base support member 148 providing structural support at the lower portion. The first guide rod 154 and the second guide rod 156 extend vertically between the top support member 146 and the base support member 148 within each fixed frame assembly 140, providing vertical guidance for the movable vertical frame 142.

The movable vertical frame 142 on each side is positioned to couple with the respective fixed frame assembly 140, allowing vertical movement of the central platform assembly 104 between an elevated position and a lowered position. The gate arm assembly 106 is mounted to the respective support structures to provide a barrier forward of the central platform assembly 104. The exploded arrangement demonstrates how the rotatable upper platform 110, the rotational rolling-element bearing 112, and the platform support assembly 114 assemble together and connect to the movable vertical frames 142 on opposing sides, which in turn interface with the fixed frame assemblies 140 to enable the vertical movement functionality of the gate assembly 100.

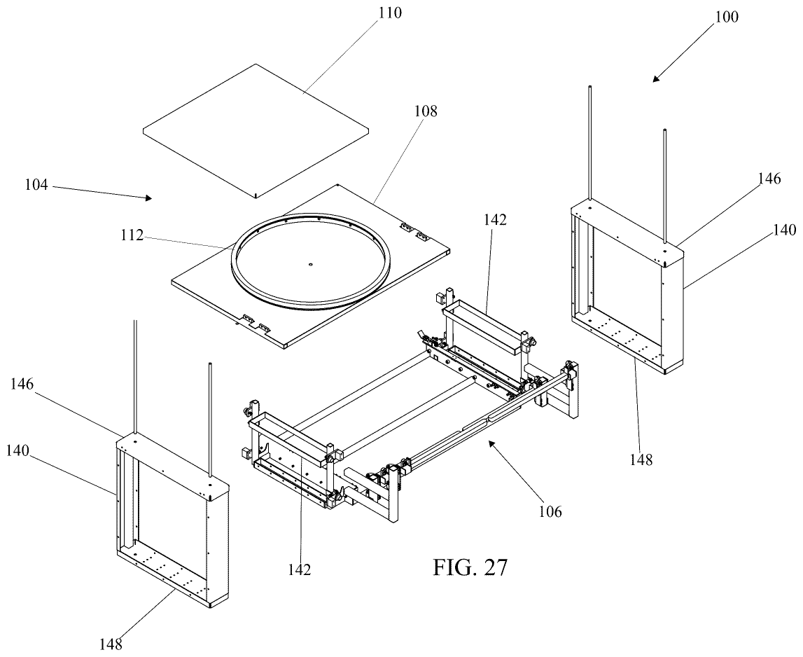

Referring to FIG. 27, an exploded view of the gate assembly 100 is shown, illustrating the relationship between the various components of the central platform assembly 104 and the supporting structures. The exploded view depicts the rotatable upper platform 110 positioned above the slidable platform 108. As described previously, the central platform assembly 104 includes the slidable platform 108 and the rotatable upper platform 110 positioned above the slidable platform 108. The rotational rolling-element bearing 112 is visible as a circular ring mechanism positioned between the rotatable upper platform 110 and the slidable platform 108, appearing as a slewing ring bearing arrangement. The rotatable upper platform 110 is configured to rotate relative to the slidable platform 108 via the rotational rolling-element bearing 112.

With continued reference to FIG. 27, the central platform assembly 104 extends between and is operably connected to the first movable vertical frame 142 and the second movable vertical frame 142. Each fixed frame assembly 140 includes the top support member 146 extending vertically upward and the base support member 148 providing structural support at the lower portion. The fixed frame assemblies 140 are positioned on opposite sides of the central platform assembly 104, forming the stationary framework that houses the movable components.

The movable vertical frame 142 on each side is positioned to couple with the respective fixed frame assembly 140, allowing vertical movement of the central platform assembly 104 between the elevated position and the lowered position. The gate arm assembly 106 is mounted to the respective support structures to provide a barrier forward of the central platform assembly 104. As described previously, the gate arm assembly 106 includes an exterior gate assembly 116 and an interior gate assembly 118. Each of the exterior gate assembly 116 and the interior gate assembly 118 includes gate side arms connected via dual axis hinges enabling movement about a first directional axis and a second directional axis.

The exploded arrangement in FIG. 27 demonstrates how the rotatable upper platform 110, the rotational rolling-element bearing 112, and the slidable platform 108 assemble together and connect to the movable vertical frames 142 on opposing sides, which in turn interface with the fixed frame assemblies 140 to enable the vertical movement functionality of the gate assembly 100. The assembly sequence illustrates that the rotational rolling-element bearing 112 is positioned between the slidable platform 108 and the rotatable upper platform 110, with the slidable platform 108 supported by the platform support assembly 114 that is fixedly attached to the movable vertical frames 142.

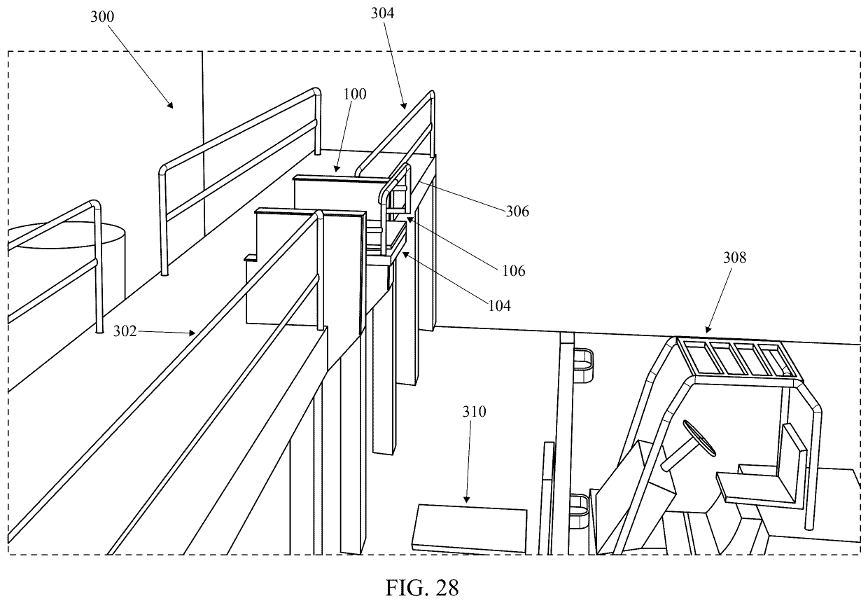

Referring to FIG. 28, a perspective operational view of the gate assembly 100 installed on a mezzanine 300 is shown when in a gate-closed, platform-elevated default position. The gate assembly 100 is positioned at an opening along a front edge perimeter 306 of the mezzanine 300, providing a safety barrier while allowing for the transfer of goods. The mezzanine 300 includes a first side safety rail 302 extending along one side and a second side safety rail 304 on the opposite side, both providing perimeter protection for workers on the elevated platform. The first side safety rail 302 and the second side safety rail 304 terminate near the gate assembly 100, maintaining continuous fall protection around the mezzanine 300.

With continued reference to FIG. 28, the central platform assembly 104 is visible within the gate assembly 100, extending between the side support assemblies 102. The gate arm assembly 106 is mounted near the top of the gate assembly 100, providing a horizontal barrier forward of the central platform assembly 104. A forklift 308 is shown positioned adjacent to the gate assembly 100, oriented to deliver or receive materials to or from the central platform assembly 104. A load 310 is depicted on the floor area near the forklift 308. The configuration demonstrates how the gate assembly 100 integrates with the existing safety infrastructure of the mezzanine 300, maintaining continuous fall protection along the front edge perimeter 306 while facilitating the transfer of materials between the forklift 308 and the elevated platform.

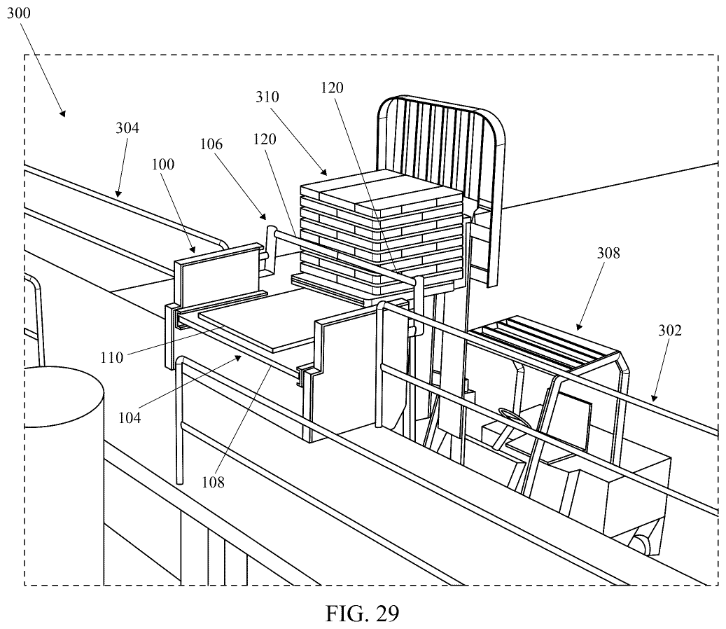

Referring to FIG. 29, a perspective operational view of the gate assembly 100 is shown in the gate-closed, platform-elevated default position, showing a load 310 prior to delivery to the gate opening. The central platform assembly 104 includes the slidable platform 108 and the rotatable upper platform 110 positioned above the slidable platform 108. The gate arm assembly 106 is mounted near the top of the gate assembly 100 and is shown in the lowered, forward position, with the exterior gate side arm 120 extending horizontally to provide a barrier forward of the central platform assembly 104.

With continued reference to FIG. 29, the mezzanine 300 includes the first side safety rail 302 extending along one side and the second side safety rail 304 on the opposite side. The first side safety rail 302 and the second side safety rail 304 terminate near the gate assembly 100, maintaining continuous fall protection around the mezzanine 300. The forklift 308 is shown positioned adjacent to the gate assembly 100, oriented to deliver materials to the central platform assembly 104. The load 310 comprising stacked materials is depicted forward of the closed gate arm assembly 106 prior to delivery to the central platform assembly 104. The configuration demonstrates how the gate assembly 100 integrates with the existing safety infrastructure of the mezzanine 300, maintaining continuous fall protection while facilitating the transfer of materials between the forklift 308 and the elevated platform.

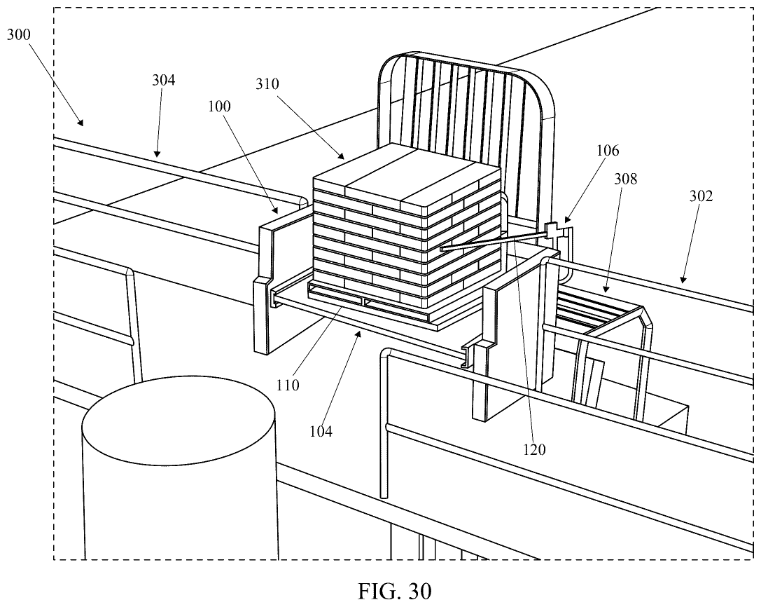

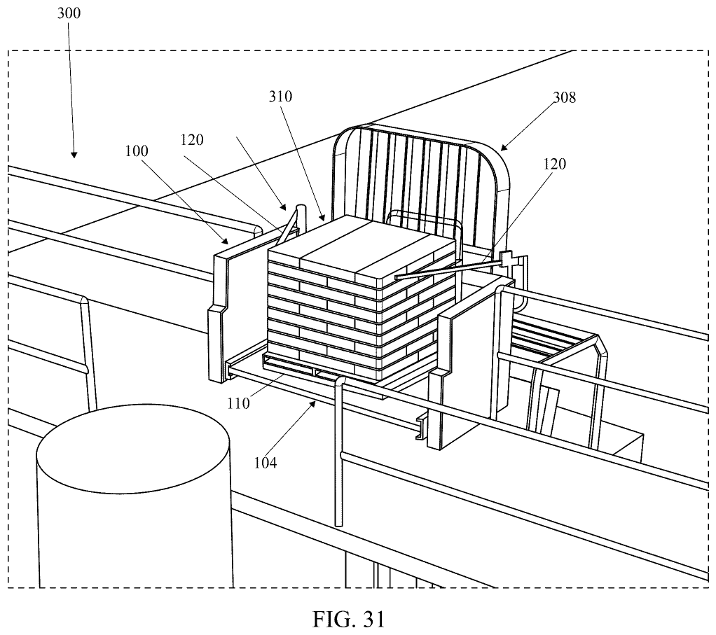

Referring to FIG. 30, a perspective operational view of the gate assembly 100 is shown receiving a load 310 onto the central platform assembly 104. The gate assembly 100 is positioned at an opening along the edge of the mezzanine 300, providing a safety barrier while allowing for the transfer of goods. The central platform assembly 104 is visible within the gate assembly 100 and is receiving the load 310 comprising stacked materials arranged on the platform surface. The rotatable upper platform 110 is positioned beneath the load 310, enabling rotational adjustment of the load 310 relative to the central platform assembly 104.

As further shown in FIG. 30, the gate arm assembly 106 is mounted near the top of the gate assembly 100, with the exterior gate side arm 120 extending rearward to provide delivery of the load 310. The mezzanine 300 includes the first side safety rail 302 extending along one side and the second side safety rail 304 on the opposite side. The first side safety rail 302 and the second side safety rail 304 terminate near the gate assembly 100, maintaining continuous fall protection around the mezzanine 300. The forklift 308 is shown positioned adjacent to the gate assembly 100, oriented to deliver or receive materials to or from the central platform assembly 104. The load 310 rests on the central platform assembly 104, indicating the operational state of the gate assembly 100 during a delivery operation.

Referring to FIG. 31, a perspective operational view of the gate assembly 100 is shown receiving a load 310, with the platform lowered and the gate arms moved rearward. The gate assembly 100 is positioned at an opening along the edge of the mezzanine 300, providing a safety barrier while allowing for the transfer of goods. The central platform assembly 104 is visible within the gate assembly 100, extending between the side support assemblies 102. The central platform assembly 104 includes the rotatable upper platform 110 positioned to support the load 310 comprising stacked materials arranged on the platform surface.

With continued reference to FIG. 31, the exterior gate side arm 120 is shown in a rearward position, allowing space for the load 310. The mezzanine 300 includes horizontal railings that provide perimeter protection for workers on the elevated platform. The first side safety rail 302 is visible extending along one side of the mezzanine 300. The forklift 308 is shown positioned adjacent to the gate assembly 100, oriented to deliver or receive materials to or from the central platform assembly 104. The load 310 rests on the rotatable upper platform 110 of the central platform assembly 104, indicating the operational state of the gate assembly 100 during a delivery operation. The configuration demonstrates how the gate assembly 100 integrates with the existing safety infrastructure of the mezzanine 300, maintaining continuous fall protection while facilitating the transfer of materials between the forklift 308 and the elevated platform.

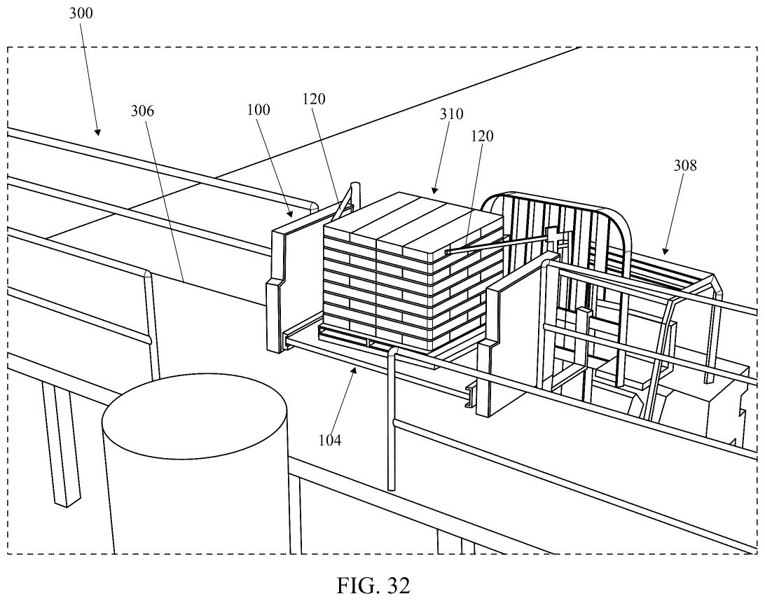

Referring to FIG. 32, a perspective operational view of the gate assembly 100 is shown with a load 310 delivered to the central platform assembly 104. The gate assembly 100 is positioned at an opening along the front edge perimeter 306 of the mezzanine 300, providing a safety barrier while allowing for the transfer of goods. The central platform assembly 104 is shown in a lowered position, extending between the side support assemblies 102 and supporting the load 310, comprising stacked materials arranged on the platform surface.

As further shown in FIG. 32, the exterior gate side arm 120 is shown extending rearward, allowing space for the load 310 while still providing a barrier between the load 310 and the front of the gate assembly 100 and the central platform assembly 104. The mezzanine 300 includes horizontal railings along the front edge perimeter 306 that provide perimeter protection for workers on the elevated platform. The forklift 308 is shown positioned adjacent to the gate assembly 100, oriented to deliver or receive materials to or from the central platform assembly 104. The configuration demonstrates how the gate assembly 100 integrates with the existing safety infrastructure of the mezzanine 300, maintaining continuous fall protection along the front edge perimeter 306 while facilitating the transfer of materials between the forklift 308 and the elevated platform. The load 310 rests on the central platform assembly 104, indicating the operational state of the gate assembly 100 during a delivery operation.

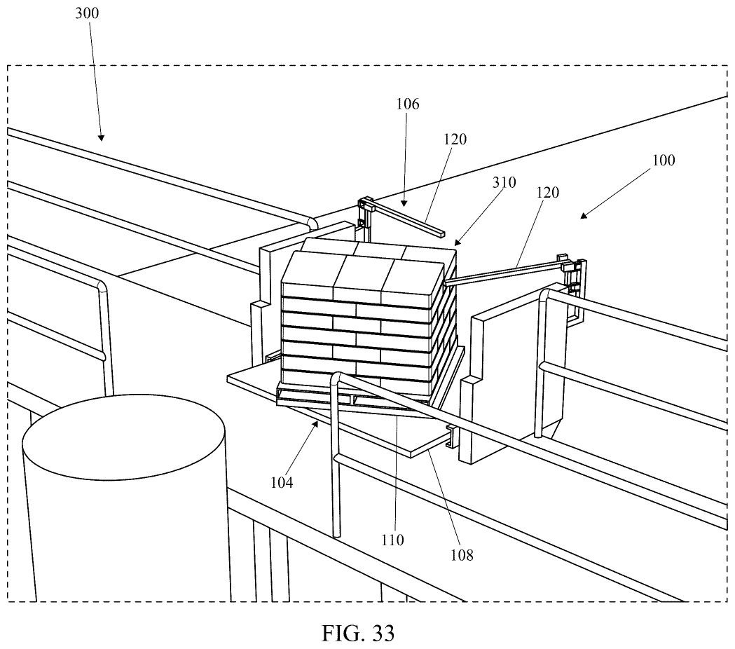

Referring to FIG. 33, a perspective operational view of the gate assembly 100 is shown with a load 310 rotated on the rotatable upper platform 110. The rotatable upper platform 110 is rotated approximately 45 degrees relative to the slidable platform 108. The gate assembly 100 is positioned at an opening along the edge of the mezzanine 300, providing a safety barrier while allowing for the transfer of goods. The central platform assembly 104 is visible within the gate assembly 100, extending between the side support assemblies 102 and supporting the load 310 comprising stacked materials arranged on the platform surface.

With continued reference to FIG. 33, the central platform assembly 104 includes the slidable platform 108 and the rotatable upper platform 110 positioned above the slidable platform 108. The rotatable upper platform 110 is shown rotated relative to the slidable platform 108, demonstrating how workers may reposition loads for convenient access during unloading operations. The gate arm assembly 106 is mounted near the top of the gate assembly 100, with the exterior gate side arm 120 extending horizontally to provide a barrier forward of the central platform assembly 104. The mezzanine 300 includes horizontal railings that provide perimeter protection for workers on the elevated platform. The load 310 rests on the rotatable upper platform 110 of the central platform assembly 104, and the rotational positioning of the rotatable upper platform 110 allows workers to access different sides of the load 310 without repositioning themselves relative to the gate assembly 100.

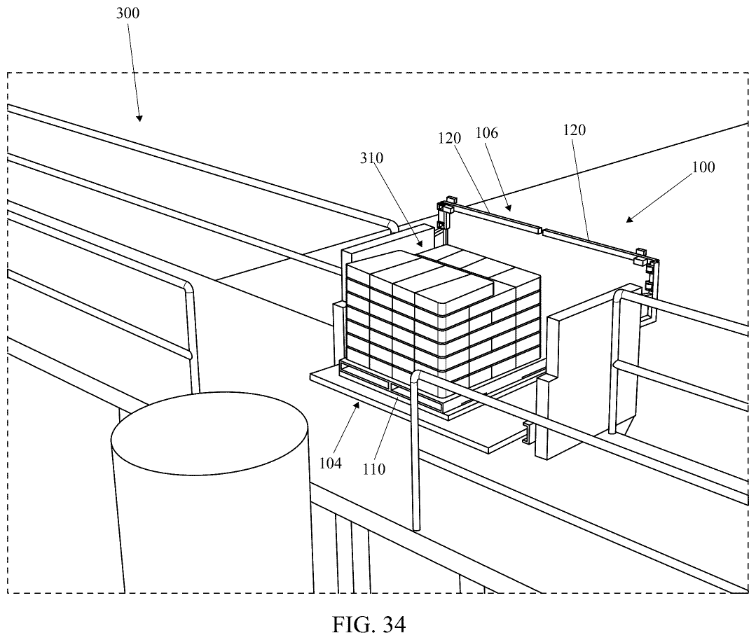

Referring to FIG. 34, a perspective operational view of the gate assembly 100 is shown in a gate-closed, platform-lowered loaded position, with the central platform assembly 104 moved rearward. The gate assembly 100 is positioned at an opening along the edge of the mezzanine 300, providing a safety barrier while allowing for the transfer of goods. The central platform assembly 104 is visible within the gate assembly 100, extending between the side support assemblies 102 and supporting the load 310 comprising stacked materials arranged on the platform surface. The central platform assembly 104 includes the rotatable upper platform 110 positioned to support the load 310.

As further shown in FIG. 34, the gate arm assembly 106 is mounted near the top of the gate assembly 100, with the exterior gate side arm 120 extending horizontally to provide a barrier forward of the central platform assembly 104. The mezzanine 300 includes horizontal railings that provide perimeter protection for workers on the elevated platform. The load 310 rests on the rotatable upper platform 110 of the central platform assembly 104, indicating the operational state of the gate assembly 100 during a delivery operation.

The slidable platform 108 is shown in a rearward position relative to the side support assemblies 102, demonstrating the horizontal sliding capability of the central platform assembly 104. By sliding the central platform assembly 104 rearward, the load 310 is displaced toward the interior of the mezzanine 300, bringing the load 310 closer to workers standing on the elevated platform. This rearward positioning allows workers to reach items on the load 310 more easily without leaning over the gate arm assembly 106 or extending beyond safe working boundaries, facilitating efficient unloading of materials while the worker remains in a stable, ergonomic working position on the mezzanine 300.

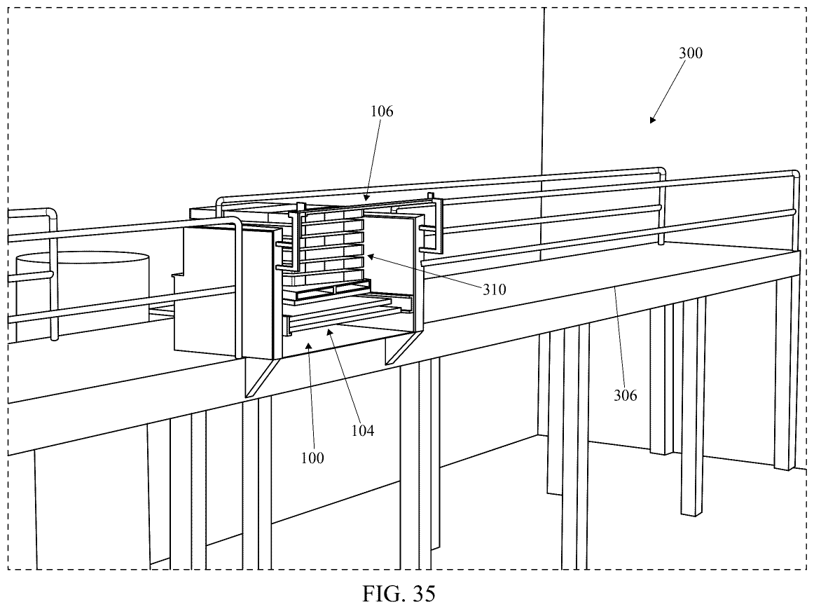

Referring to FIG. 35, a perspective operational view of the gate assembly 100 is shown in a gate-closed, platform-lowered loaded position, with the central platform assembly 104 moved rearward. The gate assembly 100 is positioned at an opening along the front edge perimeter 306 of the mezzanine 300, providing a safety barrier while allowing for the transfer of goods. The central platform assembly 104 is visible within the gate assembly 100, extending between the side support assemblies 102. The gate arm assembly 106 is mounted near the top of the gate assembly 100, providing a horizontal barrier forward of the central platform assembly 104.

With continued reference to FIG. 35, the mezzanine 300 includes horizontal railings along the front edge perimeter 306 that provide perimeter protection for workers on the elevated platform. The load 310 comprising stacked materials is shown positioned on the central platform assembly 104, indicating the operational state of the gate assembly 100 during a delivery operation. The configuration demonstrates how the gate assembly 100 integrates with the existing safety infrastructure of the mezzanine 300, maintaining continuous fall protection along the front edge perimeter 306 while facilitating the transfer of materials to and from the elevated platform.

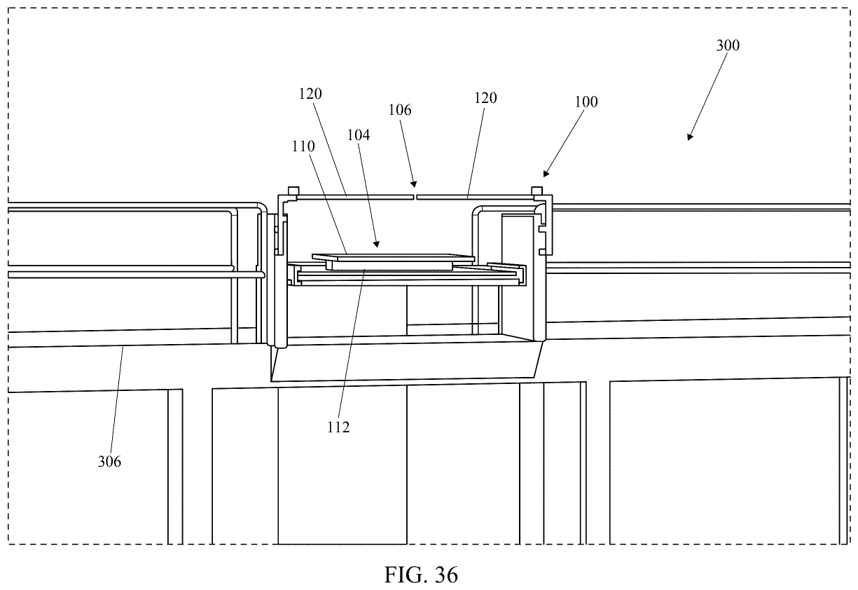

Referring to FIG. 36, a front perspective view of the gate assembly 100 is shown in a gate-closed, platform-elevated, unloaded default position, illustrating the gate assembly 100 returned to a default configuration with the load 310 removed from the central platform assembly 104. The central platform assembly 104 is shown in the upward, unloaded position, and the gate arm assembly 106 is shown in the downward, forward closed position.

With continued reference to FIG. 36, the central platform assembly 104 is visible within the gate assembly 100, extending between the side support assemblies 102. The central platform assembly 104 includes the rotatable upper platform 110 positioned to support loads placed on the platform surface. The rotational rolling-element bearing 112 is operably positioned beneath the rotatable upper platform 110, appearing as a slewing ring bearing or turntable mechanism that enables the rotatable upper platform 110 to rotate relative to the slidable platform 108. The gate arm assembly 106 is mounted near the top of the gate assembly 100, with the exterior gate side arms 120 extending horizontally to provide a barrier forward of the central platform assembly 104. The exterior gate side arms 120 are shown in the lowered, forward closed position, maintaining fall protection at the delivery opening. The mezzanine 300 includes horizontal railings along the front edge perimeter 306 that provide perimeter protection for workers on the elevated platform. The configuration demonstrates how the gate assembly 100 integrates with the existing safety infrastructure of the mezzanine 300, maintaining continuous fall protection along the front edge perimeter 306 while facilitating the transfer of materials to and from the elevated platform.

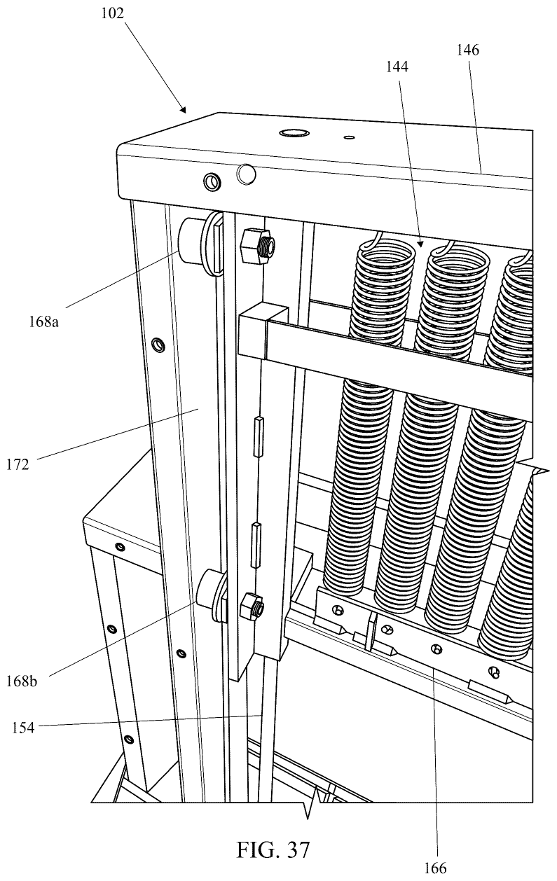

Referring to FIG. 37, a perspective view of a version of the side support assembly 102 is shown showing internal components, illustrating the internal spring configuration and the structural components that enable vertical movement of the movable vertical frame within the fixed frame assembly. The side support assembly 102 includes the top support member 146 positioned at the upper portion, providing structural support for the assembly.

The side support assembly 102 comprises the plurality of springs 144 extending vertically within the interior of the assembly. The plurality of springs 144 are connected at their lower ends to the second spring connection member 166, which is positioned at a lower portion of the movable vertical frame. The plurality of springs 144 create elastic tension between the fixed frame assembly and the movable vertical frame, enabling the self-leveling functionality of the central platform assembly 104. As a load is placed on the central platform assembly 104, the plurality of springs 144 extend and produce an upward counterforce that opposes the downward movement caused by the weight of the load. Conversely, as the load is removed from the central platform assembly 104, the tension in the plurality of springs 144 causes the movable vertical frame to translate upward, returning the central platform assembly 104 to the elevated, default position.

With continued reference to FIG. 37, the first guide rod 154 extends vertically within the side support assembly 102, providing vertical guidance for the movable vertical frame as the movable vertical frame translates between an elevated position and a lowered position. The first side parallel vertical cam guides 172 are positioned along the forward member of the fixed frame assembly, providing vertical tracks for guiding movement of the movable vertical frame.

The first-side cam follower 168a is positioned at an upper location on the movable vertical frame, and the first-side cam follower 168b is positioned at a lower location on the movable vertical frame. The first-side cam follower 168a and the first-side cam follower 168b are configured to translate along the first side parallel vertical cam guides 172, facilitating controlled vertical movement of the movable vertical frame relative to the fixed frame assembly. The positioning of the first-side cam follower 168a at the upper location and the first-side cam follower 168b at the lower location provides stable guidance throughout the vertical path of travel of the movable vertical frame.

As further shown in FIG. 37, the second spring connection member 166 extends horizontally at the lower portion of the movable vertical frame, providing attachment points for the plurality of springs 144. The arrangement demonstrates how the internal components of the side support assembly 102 interact to enable vertical movement of the central platform assembly 104 while providing counterbalancing force through the plurality of springs 144. The elastic tension created by the plurality of springs 144 between the first spring connection member positioned near the top support member 146 and the second spring connection member 166 allows the central platform assembly 104 to self-level as loads are added to or removed from the rotatable upper platform 110.

A number of implementations have been described. Nevertheless, it will be understood that various modifications may be made without departing from the spirit and scope of the disclosure. Accordingly, other implementations are within the scope of the following claims.

1. A gate assembly, comprising:
a first side support assembly including a first fixed frame assembly and a first movable vertical frame configured to move vertically with respect to the first fixed frame assembly;
a second side support assembly including a second fixed frame assembly and a second movable vertical frame configured to move vertically with respect to the second fixed frame assembly;
a central platform assembly extending between and operably connected to the first movable vertical frame and the second movable vertical frame, the central platform assembly configured to move vertically between an elevated position and a lowered position; and
a gate arm assembly mounted to at least one of the first side support assembly and the second side support assembly, the gate arm assembly providing a barrier forward of the central platform assembly.

2. The gate assembly of claim 1, wherein the central platform assembly comprises a slidable platform and a rotatable upper platform positioned above the slidable platform, the rotatable upper platform configured to rotate relative to the slidable platform.

3. The gate assembly of claim 2, further comprising a rotational rolling-element bearing operably positioned between the slidable platform and the rotatable upper platform.

4. The gate assembly of claim 3, wherein the rotational rolling-element bearing comprises a slewing ring bearing.

5. The gate assembly of claim 1, wherein the first side support assembly further comprises a first plurality of springs creating elastic tension between the first fixed frame assembly and the first movable vertical frame, and the second side support assembly further comprises a second plurality of springs creating elastic tension between the second fixed frame assembly and the second movable vertical frame.

6. The gate assembly of claim 5, wherein the central platform assembly is configured to self-level by moving vertically upward as a load is removed from the central platform assembly through tension of the first plurality of springs and the second plurality of springs.

7. The gate assembly of claim 1, wherein the gate arm assembly comprises:
an exterior gate assembly including a first exterior gate side arm and a second exterior gate side arm; and
an interior gate assembly including a first interior gate side arm and a second interior gate side arm.

8. The gate assembly of claim 7, wherein each of the first exterior gate side arm, the second exterior gate side arm, the first interior gate side arm, and the second interior gate side arm is connected via a dual axis hinge configured to enable movement about a first directional axis and a second directional axis.

9. The gate assembly of claim 8, wherein each dual axis hinge comprises a self-closing hinge configured to bias a respective gate side arm to a default closed position.

10. A gate assembly, comprising:
a first side support assembly including:
a first fixed frame assembly having at least one vertical guide rod and a first spring connection member;
a first movable vertical frame having one or more deck guides configured to couple with the at least one vertical guide rod, thereby allowing the first movable vertical frame to move vertically with respect to the first fixed frame assembly, and a second spring connection member; and
a first plurality of springs connecting the first spring connection member to the second spring connection member, thereby creating elastic tension between the first fixed frame assembly and the first movable vertical frame;
a second side support assembly including:
a second fixed frame assembly having at least one vertical guide rod and a third spring connection member;
a second movable vertical frame having one or more deck guides configured to couple with the at least one vertical guide rod of the second fixed frame assembly, thereby allowing the second movable vertical frame to move vertically with respect to the second fixed frame assembly, and a fourth spring connection member; and
a second plurality of springs connecting the third spring connection member to the fourth spring connection member, thereby creating elastic tension between the second fixed frame assembly and the second movable vertical frame;
a central platform assembly extending between and operably connected to the first movable vertical frame and the second movable vertical frame, the central platform assembly configured to move vertically between an elevated position and a lowered position responsive to a load placed thereon; and
a gate arm assembly mounted to at least one of the first side support assembly and the second side support assembly.

11. The gate assembly of claim 10, wherein the central platform assembly comprises a slidable platform and a rotatable upper platform positioned above the slidable platform, the rotatable upper platform configured to rotate relative to the slidable platform.

12. The gate assembly of claim 11, further comprising a rotational rolling-element bearing operably positioned between the slidable platform and the rotatable upper platform, wherein the rotational rolling-element bearing comprises a slewing ring bearing.

13. The gate assembly of claim 10, wherein each of the first fixed frame assembly and the second fixed frame assembly further comprises:
a top support member;
a base support member;
a forward member extending vertically between the top support member and the base support member; and
a rear member extending vertically between the top support member and the base support member.

14. The gate assembly of claim 13, wherein each of the first fixed frame assembly and the second fixed frame assembly further comprises first side parallel vertical cam guides positioned along the forward member and second side parallel vertical cam guides positioned along the rear member.

15. The gate assembly of claim 14, wherein each of the first movable vertical frame and the second movable vertical frame further comprises cam followers configured to translate along the first side parallel vertical cam guides and the second side parallel vertical cam guides.

16. The gate assembly of claim 10, wherein the gate arm assembly comprises an exterior gate assembly and an interior gate assembly, the exterior gate assembly including opposing exterior gate side arms and the interior gate assembly including opposing interior gate side arms, each of the exterior gate side arms and the interior gate side arms connected via a dual axis hinge configured to enable movement about a first directional axis and a second directional axis.

17. A gate assembly, comprising:
a first side support assembly including:
a first fixed frame assembly having a first guide rod and a second guide rod extending vertically between a top support member and a base support member, a first spring connection member positioned near the top support member, and first side parallel vertical cam guides and second side parallel vertical cam guides;
a first movable vertical frame having a first deck guide and a second deck guide configured to couple with the first guide rod and the second guide rod respectively, first side cam followers configured to translate along the first side parallel vertical cam guides, second side cam followers configured to translate along the second side parallel vertical cam guides, and a second spring connection member; and
a first plurality of springs connecting the first spring connection member to the second spring connection member;
a second side support assembly including:
a second fixed frame assembly having at least one vertical guide rod and a second spring connection member;
a second movable vertical frame configured to move vertically with respect to the second fixed frame assembly; and
a second plurality of springs creating elastic tension between the second fixed frame assembly and the second movable vertical frame;
a central platform assembly extending between and operably connected to the first movable vertical frame and the second movable vertical frame, the central platform assembly including a slidable platform and a rotatable upper platform positioned above the slidable platform, the rotatable upper platform configured to rotate relative to the slidable platform via a rotational rolling-element bearing; and
a gate arm assembly including an exterior gate assembly and an interior gate assembly, each of the exterior gate assembly and the interior gate assembly including gate side arms connected via dual axis hinges enabling movement about a first directional axis and a second directional axis.

18. The gate assembly of claim 17, wherein the first movable vertical frame further comprises a first side guide block and a second side guide block configured to provide additional guidance during vertical translation of the first movable vertical frame.

19. The gate assembly of claim 18, wherein the first side cam followers and the first side guide blocks are positioned at upper and lower locations on the first movable vertical frame, and the second side cam followers and the second side guide blocks are positioned at upper and lower locations on the first movable vertical frame.

20. The gate assembly of claim 17, wherein the central platform assembly further comprises a platform support assembly including guide rails extending along each side of the central platform assembly, upper rollers, and lower rollers engaging with the guide rails to enable horizontal sliding movement of the slidable platform relative to the first side support assembly and the second side support assembly.
